(19) United States
(12) Patent Application Publication
(10) Pub. No.: US 2007/0255661 A1
(43) Pub. Date: Nov. 1, 2007

(54) Anonymous order system, an anonymous order apparatus, and a program therefor

(76) Inventors: Takuya Yoshida, Inagi-shi (JP); Koji Okada, Tokyo (JP); Takehisa Kato, Kunitachi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/251,859

(22) Filed: Oct. 18, 2005

(30) Foreign Application Priority Data
Oct. 19, 2004 (JP) 2004-304948

(51) Int. Cl. H04K 1/00

(52) U.S. Cl. 705/74

(57) ABSTRACT

A store apparatus receives anonymous order information including an order ID and a group signature from a purchaser apparatus. The store apparatus verifies the group signature. When the group signature is verified to be valid, the store apparatus sells an article corresponding to the anonymous order information and order ID to a purchaser via a manager apparatus so as to keep the name of the article secret. Consequently, the store apparatus, serving as a service provider, need not manage personal information. This enables a user to remain anonymous. Further, the manager apparatus handles the article the name of which is kept secret. This makes it possible to protect the privacy of the contents of the order from the manager apparatus.

### CROSS-REFERENCE TO RELATED APPLICATIONS

This application is based upon and claims the benefit of priority from the prior Japanese Patent Application No. 2004-304948, filed Oct. 19, 2004, the entire contents of which are incorporated herein by reference.

### BACKGROUND OF THE INVENTION

1. Field of the Invention

The present invention relates to an anonymous order system, an anonymous order apparatus, and a program for the system and apparatus all of which use a group signature system. In particular, the present invention relates to an anonymous order system, an anonymous order apparatus, and a program for the system and apparatus all of which eliminate the need to have a service provider manage personal information and which enable a user to remain anonymous to protect the privacy of the contents of an order.

2. Description of the Related Art

A group signature is an electronic signature system proposed by D. Chaum in 1991 (D. Chaum, E. Van Heyst, “Group Signatures”, EUROCRYPT '91, LNCS 547, Springer-Verlag, pp. 257-265, 1991) and having the characteristics described below in (1) to (4). The group signature is an anonymous electronic signature.

(1) Only the members belonging to a group can use a member signature key to generate a signature representing the group (group signature).

(2) A group public key can be used to validate the group signature (verify that the signature has been generated by a group member).

(3) The group member having generated the signature cannot be identified on the basis of the group signature (anonymity).

(4) The group member having generated the group signature can be traced from the group signature using a group private key (traceability).

However, the group signature system proposed by D. Chaum et al. is not practical in terms of efficiency because, for example, signature and key sizes depend on the number of group members. Further, the system is not sufficiently secure. The requirements described below have subsequently been proposed in connection with the security to be achieved by group signature systems.

It is impossible to determine whether or not two group signatures have been generated by the same group member (unlinkability).

Even if group members conspire, they cannot generate a group signature that precludes a member from being traced (coalition resistance).

It is impossible to pretend to be a group member to generate a group signature even with the knowledge of a group private key (exculpability).

A large number of group signature systems have subsequently been proposed. One of these systems, a group signature system proposed by G. Ateniese et al. in 2000 (G. Ateniese, J. Camenisch, M. Joye and G. Tsudik. A practical and provably secure coalition-resistant group signature scheme. CRYPTO 2000, LNCS 1880, Springer-Verlag, pp. 255-270, 2000) uses signature and key sizes that do not depend on the number of group members. This group signature system proves to meet all of the above security requirements under the assumptions of strong RSA and the difficulty of the decisional Diffie-Hellman problem. This is the only system that is practicable in terms of both efficiency and security. The strong RSA assumption is that given n that meets n=pq, p=2p′+1, and q=2q′+1 (p, q, p′, and q′ are prime numbers) and an arbitrary element u ε QR(n) of a quadratic residue group QR(n) (p′q′), it is difficult to find e>1 that meets z=u^{e} (mod n). The decisional Diffie-Hellman problem is such that given g, g^{x}, g^{y}, and g^{z} ε G for a cyclic group G=<g> (in this case, the quadratic residue group QR(n)), whether or not g^{xy} and g^{z} are equal is determined.

Now, description will be given of, as a standard example, a group signature system referring “Information Security” edited and written by Mitsuko MIYAJI and Hiroaki KIKUCHI, Ohmsha, ISBN4-274-13284-6, pp. 112-114, which is similar to those described in D. Chaum, E. van Heyst, “Group Signatures”, EUROCRYPT '91. LYNCS 5547, Springer=Verlag, pp. 257-265, 1991, G. Ateniese, J. Camenisch, M. Joye and G. Tsudik, “A practical and provably secure coalition-resistant group signature scheme”, CRYPTO 2000, LNCS 1880, Springer-Verlag, pp. 255-270, 2000, and the like. The table illustrated in FIG. 19 shows symbols used in the standard group signature system and their description.

(Initialization)

A group manager GM and a tracing organization EM create respective pairs of a public key and a private key (P_{G} and S^{G}) and (P_{E} and S^{E}). The group public keys (PG and PE), a generator g, and the like are opened to the public.

A user who is a member A generates a pair of a public key and a private key (P_{A} and S_{A}) having the following relationship, on the basis of, for example, the generator g.
PA=g^{SA}

Then, the user uses the private key S_{A} to sign the public key P_{A} to obtain a digital signature Sig_{S}_{_{A}}(P_{A}). The user generates a signature SPK based on a proof of knowledge and indicating that the key pair (P_{A} and S_{A}) has been correctly generated (predicate). However, since this process is initialization, a message m is not present.
SPK{(α)|PA=g^{α}}(m)=SPK{(SA)|PA=g^{SA}}(m)

The signature SPK based on a proof of knowledge is given by (e, v) ε{0, 1}^{k}×[−2^{|L|+k}, 2^{ε(|L|+k)}] that meets e=H(g∥P_{A}∥g^{v}P_{A}^{e}∥m). The user calculates u=g^{r} on the basis of a random number rε{0, 1}^{ε(|L|+k)} to obtain e=H(g∥P_{A}∥u∥m). Thus, an integer value for v=r−eS_{A} is found.

Subsequently, the user transmits the public key P_{A}, digital signature Sig_{S}_{_{A}}(P_{A}), and signature SPK=(e, v) based on a proof of knowledge to the group manager GM.

Upon receiving them, the group manager GM uses the public key P_{A} to verify the digital signature Sig_{S}_{_{A}}(P_{A}). The group manger also uses the public key P_{A} and the generator g to verify the signature (e, v) based on a proof of knowledge. The signature based on a proof of knowledge is verified on the basis of e=H(g∥P_{A}∥g^{v}P_{A}^{e}∥m).

Upon validating the signatures through both verifications, the group manager GM uses his or her own private key S_{G} to sign the user's public key P_{A} as shown below. The group manager GM then returns an obtained member certificate σ_{A} to the user. This makes the user the member A.
σA=Sig_{SG}^{(PA)}

Further, the group manager GM stores a set of the member ID, public key, and certificate (ID_{A}, P_{A}, and σ_{A}) of the member A in secret. The group manager GM also adds the pair of the public key and digital signature of the member A (P_{A} and Sig_{S}_{_{A}}(P_{A})) to a member list.

(Generation of a Group Signature)

The member A as a signer generates, for the message m, a signature SPK_{σ}, x based on a proof of knowledge and proving that the signer has a pair of the private key and member certificate (x, σ_{A}) as shown in the formula shown below. In this case, x=S_{A}.

$$\begin{matrix}{SPK}_{σ , x} = SPK \{ ( α , β ) \vert Verify {P}_{G} ( f ( α ) , β ) = 1 \} ( m ) \\ = SPK \{ ( x , σ A ) \vert Verify {P}_{G} ( f ( x ) , σ A ) = 1 \} ( m ) \\ = ( e 1 , v 1 )\end{matrix}$$

In this formula, e1=H(g∥P A∥g^{rˆPG}∥m), and v1=r−e1 (x+σA).

The member A as a signer also generates, for the message m, a signature SPK_{C} based on a proof of knowledge and proving that the member A has a value c=E_{P E} (P_{A}) (traceability) obtained by ciphering the private key P_{A} using the public key P_{E} of the tracing organization EM and the private key x corresponding to a plaintext (P_{A}) of the value c as shown in the following formula.

$$\begin{matrix}{SPK}_{c} = SPK \{ ( α , β ) \vert Verify {P}_{E} ( f ( α ) , β ) = 1 \} ( m ) \\ = SPK \{ ( x , c ) \vert Verify {P}_{E} ( f ( x ) , c ) = 1 \} ( m ) \\ = ( e 2 , v 2 )\end{matrix}$$

In this formula, e2=H(g∥PA∥g^{rˆPE}∥m) and v2=r−e2(x+c).

Subsequently, the member A transmits the message m and the data (SPK_{94 , x}, c, and SPK_{C}) to a verifier as a signature. In this case, c may be a value c=E_{P E} (σA) obtained by ciphering the certificate σ_{A}.

(Verification of the Group Signature)

Upon receiving the message m and the data (SPK_{σ,x}, c, and SPK_{C}) as a signature, the verifier verifies the signature SPK_{σ,x}=(e1, v1) and SPK_{C}=(e2, v2) on the basis of the group public keys P_{G} and P_{E}.
e1=H(g∥PA∥g^{v1ˆPG}PA^{e1ˆ}PG∥m)
e2=H(g∥PA∥g^{v2ˆPE}PA^{e2ˆPE}∥m)

When the signature generated by the member A is valid, the verifier executes a process based on the message m. Conversely, when the signature generated by the member A is invalid, the verifier transmits the ciphered value c to the tracing organization EM.

(Tracing)

The tracing organization EM uses its own private key SE to decipher the value c (=E_{P E} (P A)) received from the verifier s. The tracing organization EM then transmits the obtained public key P_{A} of the member A to the group manager GM. The group manager GM identifies the member A on the basis of the public key P_{A}.

The standard group signature system has been described. The other group signature systems have similar characteristics.

The present inventor's examinations indicate that when an article or service is ordered online, the problems described below may occur in connection with anonymity and the privacy of the contents of the order.

In regard to the anonymity, costs and risks of personal information management are continuously increasing. It is undesirable that service providers cannot provide service unless they manage personal information. Further, it is undesirable for service users that a plurality of service providers manage personal information.

However, general orders require personal information to be passed to service providers. It is possible to pass personal IDs without passing personal information. However, the perfect anonymity cannot be realized using personal IDs. This is because it is possible to determine whether or not different orders are made by the same service user; this in turn makes it possible to determine the user's order history and thus the user's hobbies and ideas. Moreover, if the personal ID is passed, orders cannot be efficiently processed by a system in which an ordering procedure involves not only transmissions to and from a service provider but also accesses to a management server for personal information. Jpn. Pat. Appln. KOKAI Publication No. 2004-54905 efficiently and perfectly anonymously provides online services using group signatures. However, it does not consider the purchase of articles involving distribution.

In regard to the privacy of the contents of an order, all of the above methods allow service providers to know who has placed an order and what has been ordered. This is undesirable in terms of privacy protection.

Moreover, even if the anonymity and the privacy for the contents of an order are taken into account, a mechanism is required which enables service providers to acquire market information.

### BRIEF SUMMARY OF THE INVENTION

The present invention is made in view of the above circumferences. It is an object of the present invention to provide an anonymous order system, an anonymous order apparatus, and a program for the system and apparatus which eliminate the need for management of personal information carried out by service providers providing services different from online ones, thus allowing users to remain anonymous.

It is another object of the present invention to provide an anonymous order system, an anonymous order apparatus, and a program for the system and apparatus which can protect the privacy of the contents of an order.

It is another object of the present invention to provide an anonymous order system, an anonymous order apparatus, and a program for the system and apparatus which enables service providers to acquire market information while realizing anonymity and the protection of privacy of the contents of an order.

A first aspect of the present invention is an anonymous order system which uses a group signature system having a tracing function to execute an anonymous order for a sales target comprising an article or service and sale of the sales target in accordance with the anonymous order, the system comprising a manager apparatus which stores, in a storage device, personal information and group signature related information on a purchaser who places the anonymous order and which, on the basis of anonymous order information received from a store and including an order ID and a group signature, uses the tracing function to identify a corresponding part of the personal information stored in the storage device, on the basis of group signature related information obtained by deciphering the group signature, the manager apparatus then outputting the personal information obtained by the identification so as to allow an external delivery section to carry out delivery, a store apparatus which issues an order ID to a purchaser apparatus of the purchaser and which, upon receiving anonymous order information including the order ID and a group signature from the purchaser apparatus, verifies the group signature and when the group signature is verified to be valid, transmits the anonymous order information to the manager apparatus, and the purchaser apparatus which, upon receiving the order ID from the store apparatus, is operated by the purchaser to generate anonymous order information including the order ID and a group signature and transmitting the anonymous order information obtained to the store apparatus.

A second aspect of the present invention is a purchaser apparatus used in an anonymous order system which uses a group signature system having a tracing function to execute an anonymous order for a sales target comprising an article or service, the purchaser apparatus being able to communicate with both a manager apparatus which manages a purchaser who places the anonymous order as a member of the group signature system and which, upon receiving anonymous order information including an order ID and a group signature, uses the tracing function to identify the purchaser on the basis of the group signature and a store apparatus which issues an order ID to a purchaser apparatus of the purchaser and which, upon receiving anonymous order information including the order ID and a group signature from the purchaser apparatus, verifies the group signature and when the group signature is verified to be valid, transmits the anonymous order information to the manager apparatus, the purchaser apparatus comprising a target information transmitting section which transmits sales target identification information to the store apparatus in response to an operation preformed by the purchaser, a basic information generating section which, upon receiving an order ID from the store apparatus in response to the transmission, generates order basic information including the order ID but not including the sales target identification information, a detailed information generating section which generates order detailed information in which the sales target identification information is kept secret, a group signature generating section which generates the group signature using the group signature system, an editing section which edits a message portion containing at least the order detailed information and the store secret information as well as the group signature to obtain the anonymous order information, and an anonymous information transmitting section which transmits the anonymous order information obtained by the editing section to the store apparatus.

A third aspect of the present invention is a manager apparatus used in an anonymous order system which uses a group signature system having a tracing function to execute an anonymous order for a sales target comprising an article or service and sale and provision of the sales target in accordance with the anonymous order, the manager apparatus being able to communicate with both a purchaser apparatus of a purchaser who places the anonymous order and a store apparatus of a store which carries out the sale and storing personal information and group signature related information on the purchaser in a storage device for management, the manager apparatus comprising a purchaser identifying section which, upon receiving anonymous order information including an order ID and a group signature from the store or store apparatus, uses the tracing function to identify the personal information on the corresponding purchaser stored in the storage device, on the basis of group signature related information obtained by deciphering the group signature, a market information generating section which deletes information which enables the individual to be identified, from the personal information obtained by the identification to generate market information, and a market information transmitting section which transmits the market information obtained to the store apparatus.

(Effects)

According to the first aspect of the present invention, upon receiving the anonymous order information including the order ID and group signature from the purchaser apparatus, the store apparatus transmits the anonymous order information to the manager apparatus when the group signature is verified to be valid. On the basis of the anonymous order information, the manager apparatus uses the tracing function to identify the corresponding personal information stored in the storage device, on the basis of the group signature related information obtained by deciphering the group signature. The manager apparatus then outputs the personal information so as to allow the external delivery section to carry out delivery. The external delivery section delivers the sales target to the purchaser on the basis of the personal information.

Consequently, the store apparatus, serving as a service provider, need not manage the personal information. This enables user anonymity to be realized. Further, the manager apparatus handles the anonymous order information to enable the privacy of the contents of the order to be protected from the manager apparatus.

Furthermore, the second aspect of the present invention also produces the above effects and additionally provides the purchase apparatus configured as described below. The secret message generating section of the purchaser apparatus uses the public key of the store apparatus to cipher a message sent to the store to generate a store secret message. The editing section of the purchaser apparatus then edits the anonymous order information so that the information contains the store secret message. This enables the message to be transmitted to the store while keeping it secret from third parties.

Furthermore, the third aspect of the present invention also produces the above effects and additionally provides the manager apparatus configured as described below. The market information generating section of the manager apparatus deletes the information that enables the individual to be identified, from the personal information obtained by the identification to generate market information. The market information transmitting section of the manager apparatus then transmits the market information to the store apparatus. This makes it possible to provide the store with the market information on the order while keeping the purchaser secret.

As described above, according to the present invention, the service provider need not manage the personal information. This allows the user to remain anonymous. Further, the privacy of the contents of the order can be protected. Moreover, the service provider can acquire market information while realizing anonymity and the protection of the privacy of the contents of an order.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic diagram showing the configuration of an anonymous order system in accordance with a first embodiment of the present invention;

FIG. 2 is a schematic diagram illustrating a distribution company storage device in accordance with the first embodiment;

FIG. 3 is a schematic diagram illustrating a store storage device in accordance with the first embodiment;

FIG. 4 is a schematic diagram illustrating order information and the like in accordance with the first embodiment;

FIG. 5 is a schematic diagram illustrating a purchaser storage device in accordance with the first embodiment;

FIG. 6 is a schematic diagram illustrating anonymous order information and the like in accordance with the first embodiment;

FIG. 7 is a sequence diagram illustrating an initializing operation in accordance with the first embodiment;

FIG. 8 is a schematic diagram illustrating a startup operation in accordance with the first embodiment;

FIG. 9 is a schematic diagram illustrating a store registering operation in accordance with the first embodiment;

FIG. 10 is a schematic diagram illustrating a purchaser registering operation in accordance with the first embodiment;

FIG. 11 is a sequence diagram illustrating an anonymous ordering, delivering, and settling operations in accordance with the first embodiment;

FIG. 12 is a schematic diagram illustrating the anonymous ordering operation in accordance with the first embodiment;

FIG. 13 is a schematic diagram illustrating the anonymous ordering operation in accordance with the first embodiment in detail;

FIG. 14 is a schematic diagram illustrating an anonymous order verifying operation in accordance with the first embodiment;

FIG. 15 is a schematic diagram illustrating the article delivering and setting operation in accordance with the first embodiment;

FIG. 16 is a schematic diagram illustrating a signer identifying and market information generating operation in accordance with the first embodiment;

FIG. 17 is a sequence diagram illustrating operations of an anonymous order system in accordance with a second embodiment of the present invention;

FIG. 18 is a sequence diagram illustrating operations of an anonymous order system in accordance with a third embodiment of the present invention; and

FIG. 19 is a table showing symbols for a standard group signature system and their description.

### DETAILED DESCRIPTION OF THE INVENTION

Embodiments of the present invention will be described below with reference to the drawings. In the description of the embodiments, a typical example of an anonymous order system consists of a distribution company (group manager or tracing organization), a purchaser (member or signer), and a store (sign verifier) and is applied to online article purchase involving distribution. Further, a typical example described below for the embodiments is group signatures disclosed in “Information Security” edited and written by Mitsuko MIYAJI and Hiroaki KIKUCHI, Ohmsha, ISBN4-274-13284-6, pp. 112-114, described above. However, the present invention is not limited to this but can also be applied to an arbitrary group signature system by modifying the message m to m=(m1∥H(m2)) or m=(m1∥H(m2)∥EP_{SP}(m3)∥E_{GM}(m4)).

### First Embodiment

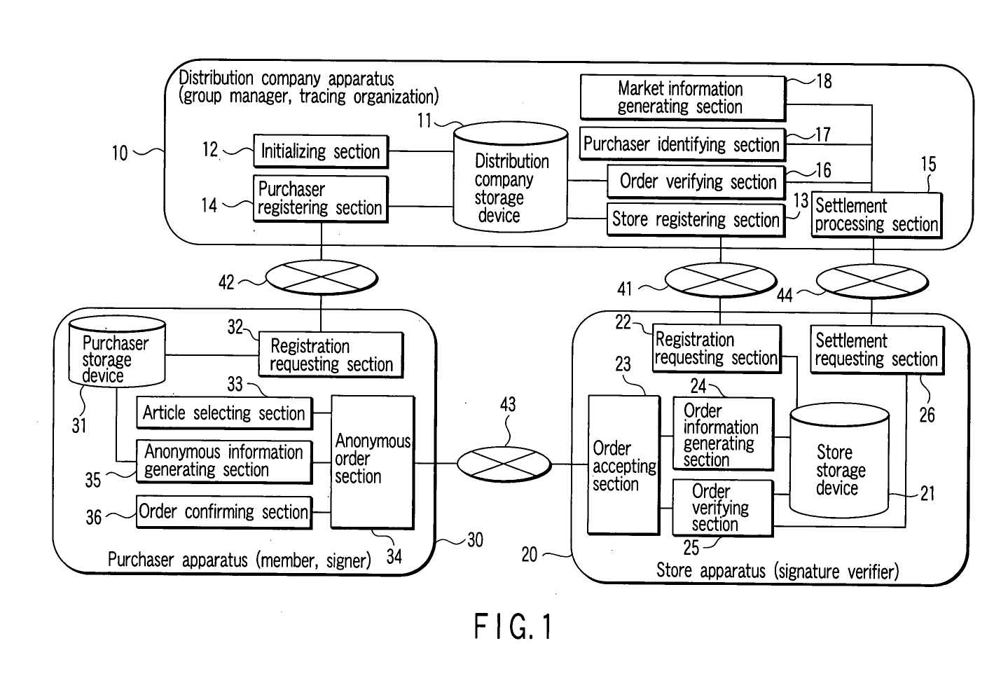

FIG. 1 is a schematic diagram showing the configuration of an anonymous order system in accordance with a first embodiment of the present invention. The anonymous order system comprises a distribution company apparatus 10, a store apparatus 20, and a purchaser apparatus 30 connected together via networks 41 to 44.

The distribution company apparatus 10 comprises a distribution company storage device 11, an initial setting section 12, a store registering section 13, a purchaser registering section 14, a settlement processing section 15, an order verifying section 16, a purchaser identifying section 17, and a market information generating section 18.

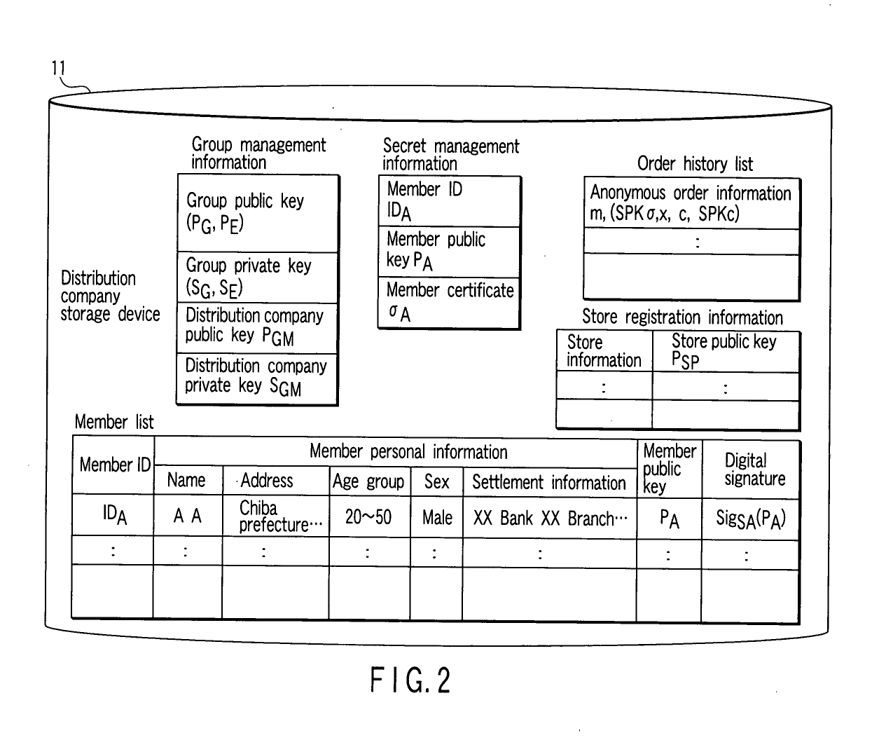

The distribution company storage device 11 is a memory on which the section 12 to 18 can perform a read or write operation. As shown in FIG. 2, the distribution company storage device 11 stores group management information, secret management information, a member list, store registration information, and an order history list.

The group management information consists of group public keys (P_{G} and P_{E}), group private keys (S_{G} and S_{E}), a distribution company public key P_{GM}, and a distribution company private key S_{GM}.

The secret management information (group signature related information on a purchaser) consists of a member ID, a member public key P_{A}, and a member certificate σ_{A} for each member

The member list consists of member personal information, a member public key P_{A}, and a digital signature Sig_{SA} (P_{A}) for each member ID. The member personal information consists of, for example, a name, an address, an age group, the sex, settling information (bank account information, a credit card number, or the like), and the like. The member personal information may include network address information such as an E mail address or an. IP address or a telephone number as desired. The member public key in the member list also corresponds to the group signature related information on the purchaser.

The order history list contains anonymous order information m on past orders.

The initializing section 12 is used only once during system startup. The initializing section 12 has a function for generating pairs of the group public and private keys (P_{G} and S_{G}) and (P_{E} and S^{E}), a function for generating a pair of the distribution company public and private keys (P_{GM} and S_{GM}), and a function for writing group management information consisting of the generated key pair to the distribution company storage device 11.

The store registering section 13 has a function for writing store registration information received from the store apparatus 20 and including store information and a store public key PSP when the store is registered, and a function for returning the group public keys (P_{G} and P_{E}) in the distribution company storage device 11 to the store apparatus 20 after the write operation.

The purchaser registering section 14 has a function for examining whether or not the purchaser is allowed to receive an anonymous order service on the basis of the personal information received from the purchaser apparatus 30, a function for notifying the purchaser apparatus 30 of the result of the examination, a function for carrying out challenge and response authentication with the purchase apparatus 30 when the purchaser passes the examination, a function for verifying the digital signature Sig_{SA} (P_{A}) and a signature SPK based on a proof of knowledge which are received from the purchaser apparatus 30, a function for using the group private key S_{G} to sign the member public key P_{A} to create a member certificate σ_{A} (=Sig_{SG} (P_{A})), a function for storing secret management information consisting of a set (ID_{A}, P_{A}, and σ_{A}) of the member ID, public key, and certificate of the member A, in a tamper-resistant region of the distribution company storage device 11 and adding a pair (P_{A} and Sig_{SA} (P_{A})) of the member public key P_{A} and digital signature, and a function for transmitting the member certificate σ_{A} to the purchaser apparatus 30.

The settlement processing section 15 has a function for carrying out representative settlement on the basis of the member personal information described in the member list stored in the distribution company storage device 11.

The order verifying section 16 has a function for, upon receiving anonymous order information from the store, checking whether or not the same information is contained in the order history list in the distribution company storage device 11 and if the same information is contained in the list, determining that the request is invalid to reject article delivery and settlement, the function otherwise validating the group signature contained in the anonymous order information, a function for rejecting article delivery and settlement if the signature is invalid, and a function for, only if the signature is verified to be valid, accepting and adding the anonymous order information to the order history list and saving the information to the distribution company storage device 11.

The purchaser identifying section 17 has a tracing function for using the group private key S_{E} to decipher the group signature c (=E_{P E} (P A)) contained in the anonymous order information and then using the member public key P_{A} obtained to refer the member list to identity the signer (=purchaser).

The market information generating section 18 deletes information (for example, the address or name) enabling the individual to be identified, from the information on the identified signer to generate market information. The market information generating section 18 has a function for transmitting the market information obtained to the store apparatus 20. The market information belongs to the information on the order but does not enable the individual to be identified. The market information is effective in indicating a purchase group for the article.

The store apparatus 20 comprises a store storage device 21, a registration requesting section 22, an order accepting section 23, an order information generating section 24, an order verifying section 25, and a settlement requesting section 26.

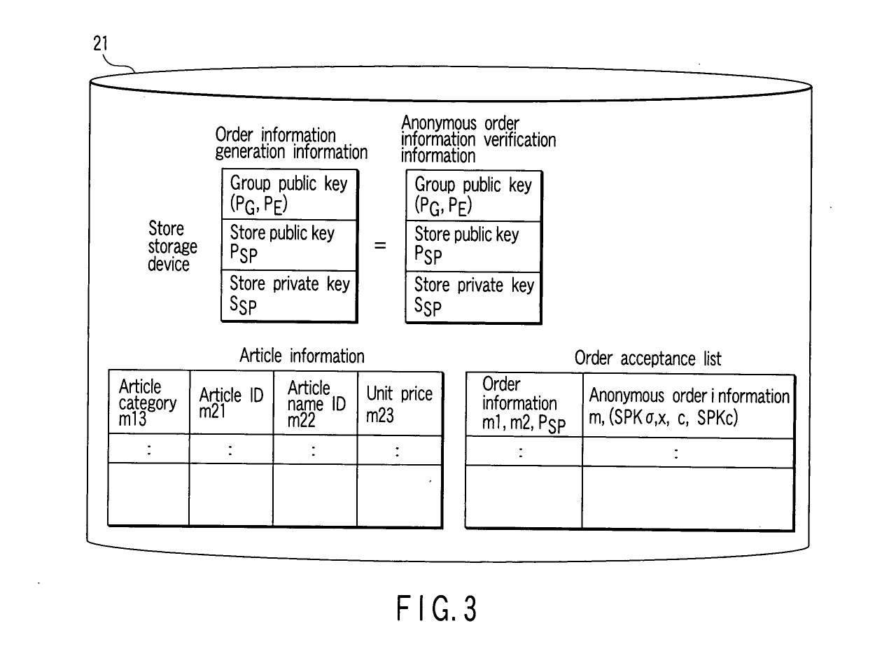

The store storage device 21 is a memory on which the sections 22 to 26 can perform a read and write operations. As shown in FIG. 3, the store storage device 21 stores order information generation information (=anonymous order information verification information), article information, and an order acceptance list.

The order information generation information consists of the group public keys (P_{G} and P_{E}), the store public key P_{SP}, and a store private key S_{SP}.

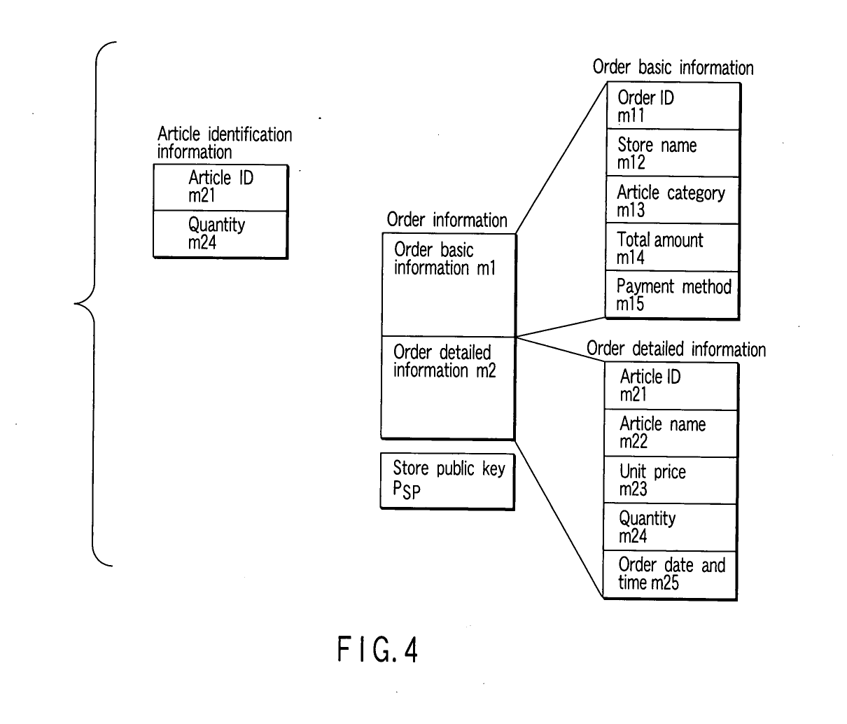

The article information is related information used to create order information from article identification information (sales target identification information) received from the purchaser apparatus 30. The article information contains, for example, an article category m13, an article ID m21, an article name m22, and a unit price m23. The article identification information is used to identify the article provided by the store. Further, the article identification information should be kept secret from the manager. As shown in FIG. 4, the article ID (for example, an article number) m21, quantity m24, and the like can be used as the article identification information.

The order acceptance list contains order information m1 and m2 and anonymous order information m and (SPK_{σ,x}, c, and SPK_{C}) received from the purchaser information 30.

The order information includes order basic information m1 and order detailed information m2.

The order basic information m1 is the minimum information required to receive payment of the price of the article. The order basic information consists of, for example, an order ID m11, a store name m12, an article category m13, a total amount m14, and a payment method m15.

The order detailed information m2 belongs to the information on the article and is desirably kept secret from all the related parties except the store (=the manager and the like) in terms of privacy. The order detailed information m2 contains at least article identification information and may contain any other information. The order detailed information m2 contains of, for example, the article ID m21, the article name m22, the unit price m23, the quantity m24, and an order date and time m25.

The anonymous order information will be described later.

The registration requesting section 22 has a function for transmitting store information and the store public key P_{SP} to the distribution company apparatus 10 in response to an operation performed by a store clerk, and a function for wiring the group public keys (P_{G} and P_{E}) received from the distribution company apparatus 10 to the store storage device 22.

The order accepting section 23 has an interface function located between the purchaser apparatus 30 and the sections 24 and 25 in the store apparatus 20.

The order information generating section 24 has a function for generating order basic information m1 and order detailed information m2 from the article identification information received from the purchaser apparatus 30, on the basis of the order information generation information, and a function for transmitting the order information m obtained and the store public key P_{SP} to the purchaser apparatus 30.

The order verifying section 25 has a function for, upon receiving the anonymous order information from the purchaser apparatus 30, validating the anonymous order information on the basis of the anonymous order verification information stored in the store storage device 21, a function for, if the anonymous order information is verified to be valid, accepting the order and saving the order information and anonymous order information in the store storage device 21, and a function for issuing a slip showing the anonymous order information and the order ID described in place of a destination.

The settlement requesting section 26 has a function for transmitting the anonymous order information to the distribution company apparatus 10 to request settlement and a function for, after the settlement is finished, saving market information received from the distribution company apparatus 10, to the distribution company storage device 11. The present embodiment does not use the settlement requesting function of the settlement requesting section 26 because it allows settlement to be requested using the anonymous order information described in the slip. However, the settlement requesting function can be suitably used if, for example, the article is a digital content.

The purchaser apparatus 30 comprises a purchaser storage device 31, a registration requesting section 32, an article selecting section 33, an anonymous order section 34, an anonymous information generating section 35, and an order confirming section 36.

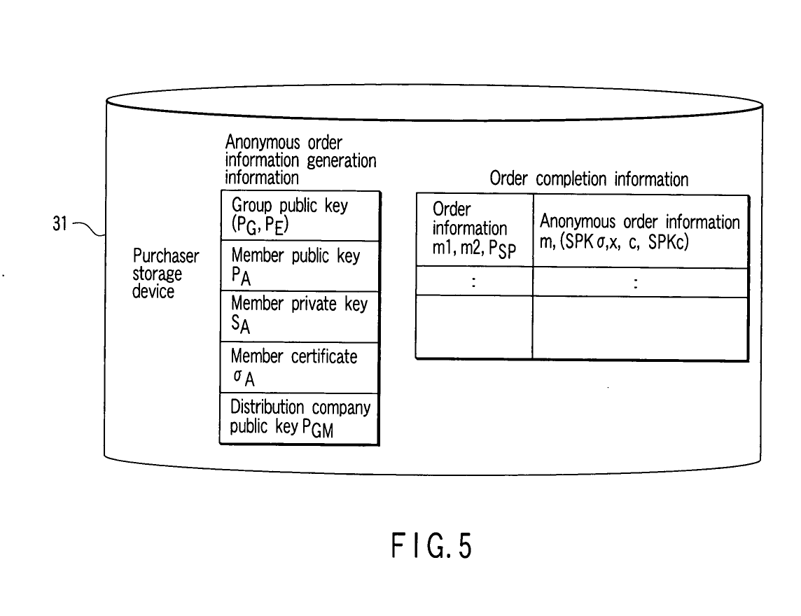

The purchaser storage device 31 is a memory on which the sections 32 to 35 can perform a read and write operations. As shown in FIG. 5, the purchaser storage device 31 stores anonymous order information generation information and order completion information.

The anonymous order information generation information consists of the group public keys (P_{G} and P_{E}), the member public key P_{A}, a member private key S_{A}, the member certificate σ_{A}, and the distribution company public key P_{GM}.

The order completion information consists of the order information m1 and m2 and the anonymous order information m and (SPK_{σ,x}, c, and SPK_{C}).

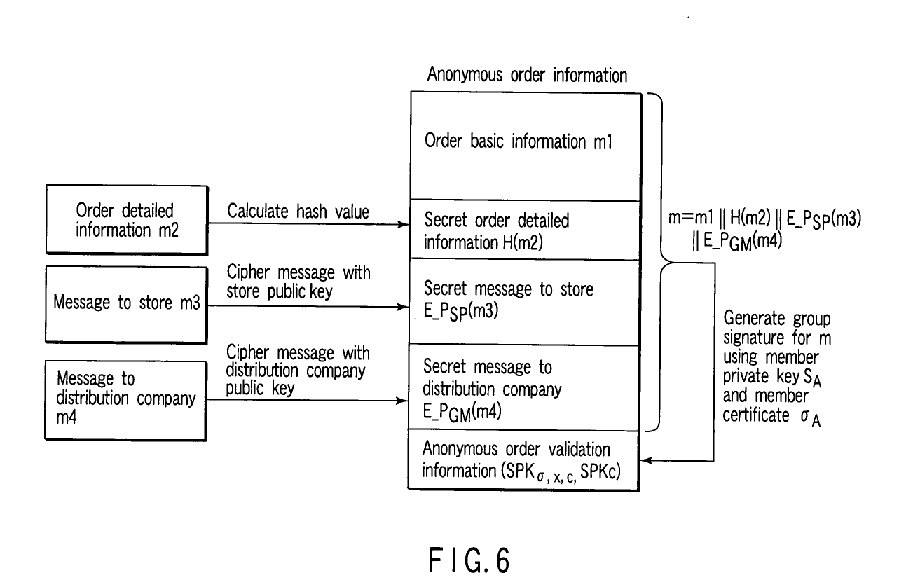

As shown in FIG. 6, the anonymous order information includes the order basic information m1, anonymous order detailed information H (m2), a secret message E_{P SP} (m 3) to the store, a secret message E_{P GM} (m 4) to the distribution company, and anonymous order validation information (SPK_{σ,x}, c, and SPK_{C}).

The anonymous order detailed information H (m2) cannot be made without knowing the order detailed information m2. The anonymous order detailed information H (m2) is utilized by the store receiving the order, to validate the anonymous order information. However, it is unnecessary that the order detailed information m2 can be restored from anonymous order detailed information H (m2). Accordingly, although the hash value H (m2) is used in this case, the present invention is not limited to this. The order detailed information m2 may be ciphered using the store public key P_{GM}.

The secret message E_{P SP} (m 3) to the store is desired by the purchaser to be transmitted only to the store. The secret message E_{P SP} (m 3) is, for example, the number of a coupon or a discount keyword and is ciphered in a form that can be deciphered only by the store.

The secret message E_{P GM} (m4) to the distribution company is desired by the purchaser to be transmitted only to the distribution company. The secret message E_{P GM} (m4) is, for example, the destination of the article and is ciphered in a form that can be deciphered only by the distribution company.

The anonymous order validation information (SPK_{σ,x}, c, and SPK_{C}) is a group signature used to validate the anonymous order information. The order verifying section 25 can validate the anonymous order information on the basis of the anonymous order verification information. This enables the store to check whether or not to accept the order but prevents the store from acquiring the personal information. Further, the purchaser identifying section 14 can validate the anonymous order information on the basis of the anonymous order validation information and the group management information. If the anonymous order information is found to be valid, the purchaser having generated the anonymous order information can be identified.

The registration requesting section 32 has a function for transmitting the personal information to the distribution company apparatus 10 in response to an operation performed by the purchaser, a function for, on the basis of the notification that the purchaser has passed the examination made by the distribution company apparatus 10, generating and writing a pair of the member public and private keys (P_{A} and S_{A}) to the purchaser storage device 31, a function for carrying out challenge and response authentication with the distribution company apparatus 10, a function for generating and transmitting a digital signature Sig_{SA} (P_{A}) and a signature SPK=(e, v) based on a proof of knowledge to the distribution company apparatus 10, and a function for saving the member certificate σ_{A} received from the distribution company apparatus 10, to the purchaser storage device 31.

The article selecting section 33 transmits the article identification information and the order request to the store apparatus in response to an operation performed by the purchaser.

The anonymous order section 34 has an interface function located between the store apparatus 20 and the sections 33, 35, and 36 in the purchaser apparatus 30.

In response to an operation performed by the purchaser, the anonymous information generating section 35 generates anonymous order information from the order basic information m1 and order detailed information m2 on the basis of the anonymous order generation information stored in the purchase storage device 31. The anonymous information generating section 35 has a function for transmitting the anonymous order information obtained to the store apparatus 20 via the anonymous order section 34.

The order confirming section 36 has a function for displaying the order basic information m1 and order detailed information m2 received from the store apparatus 20, on a screen to prompt the purchaser to confirm the contents of the order.

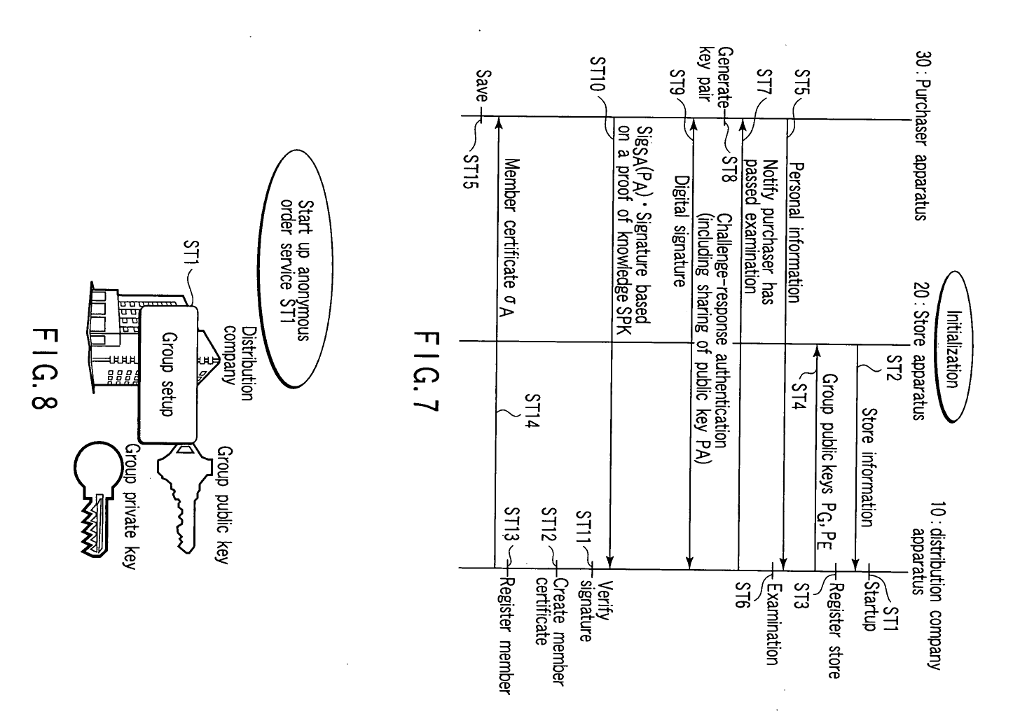

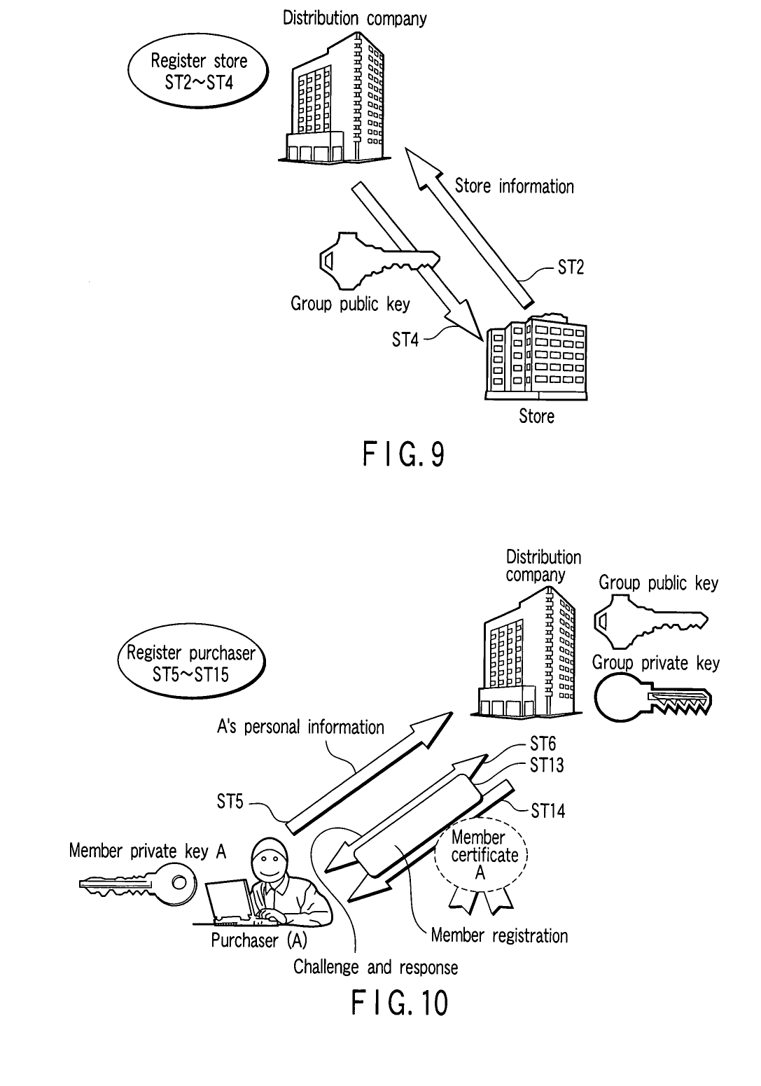

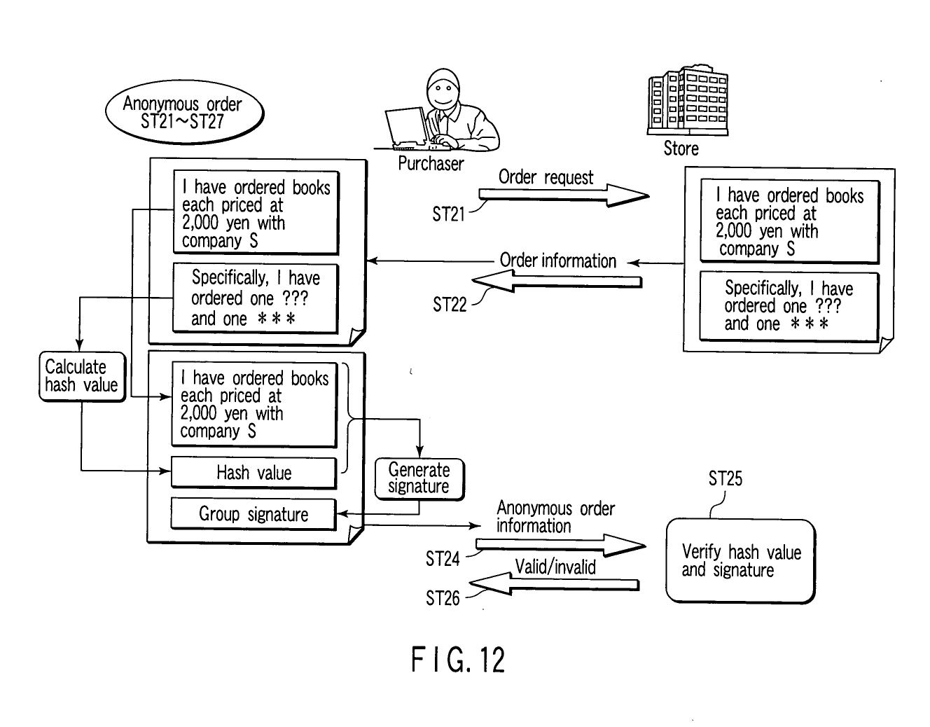

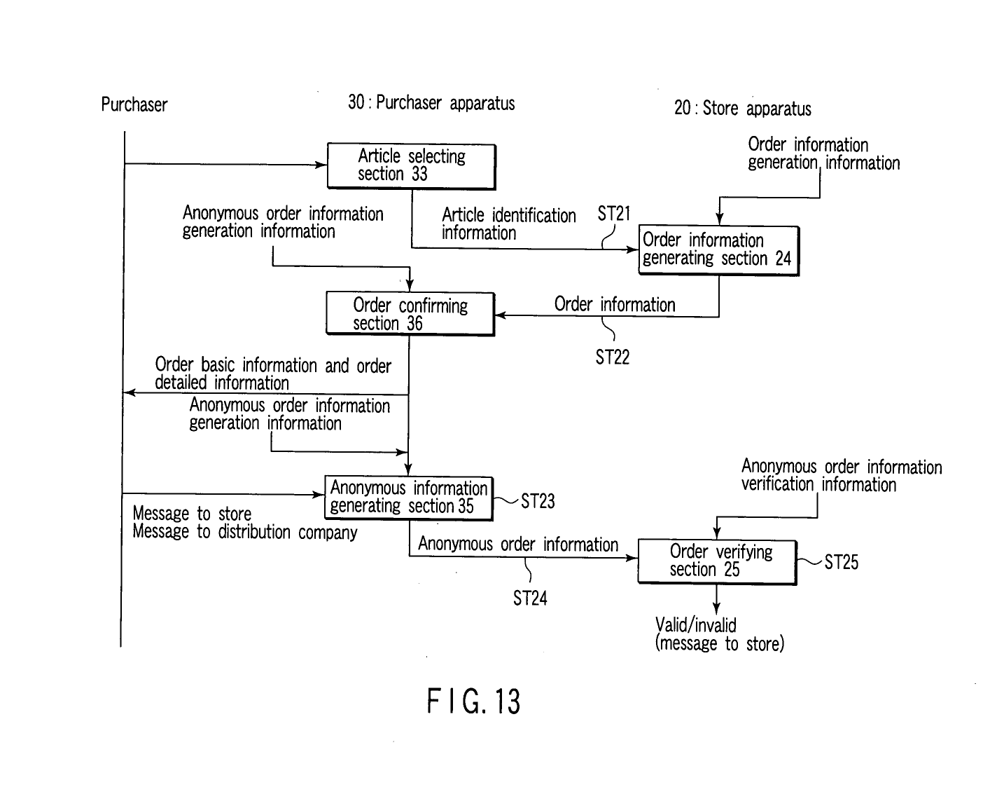

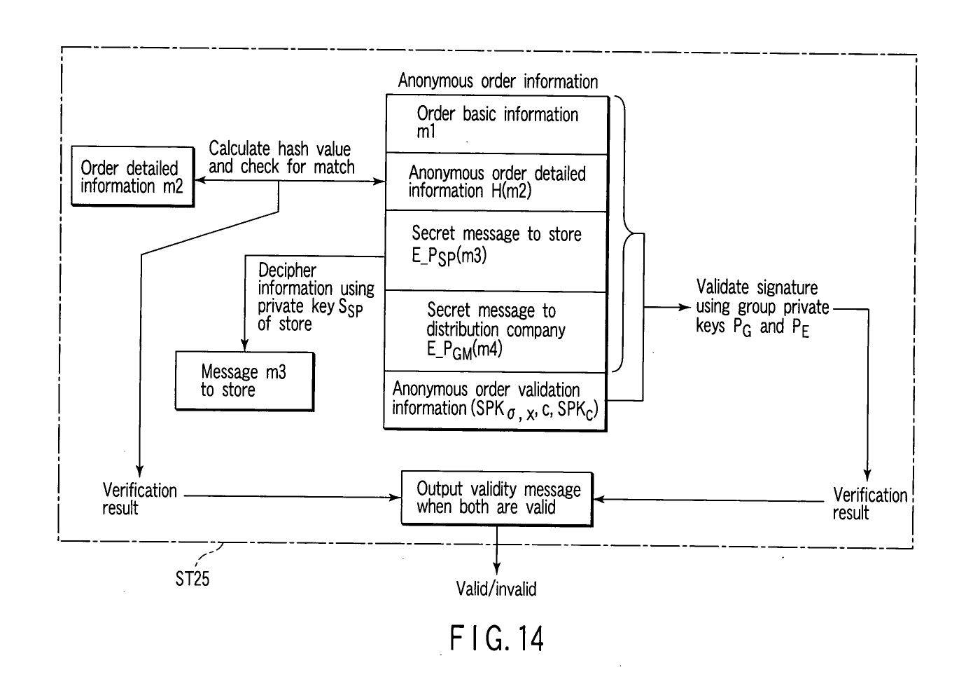

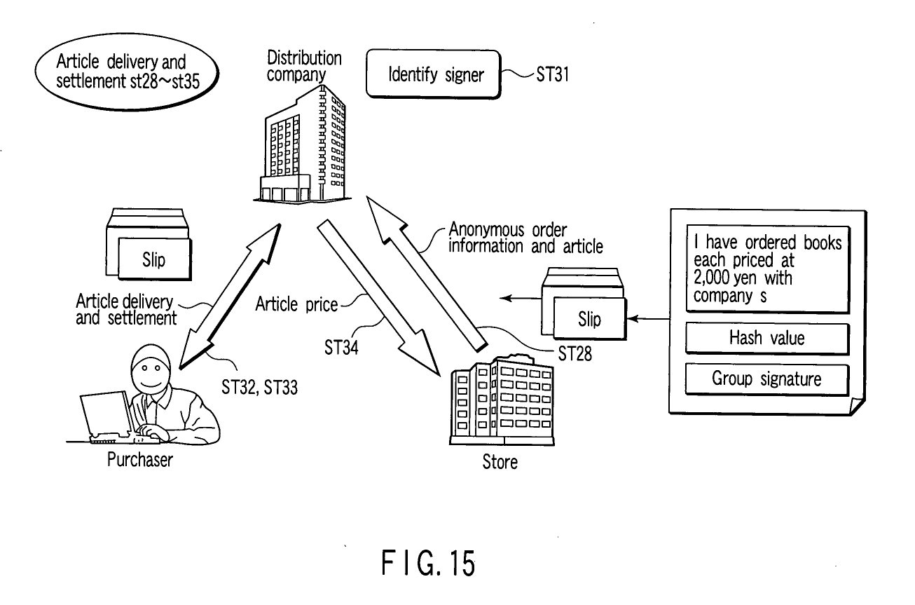

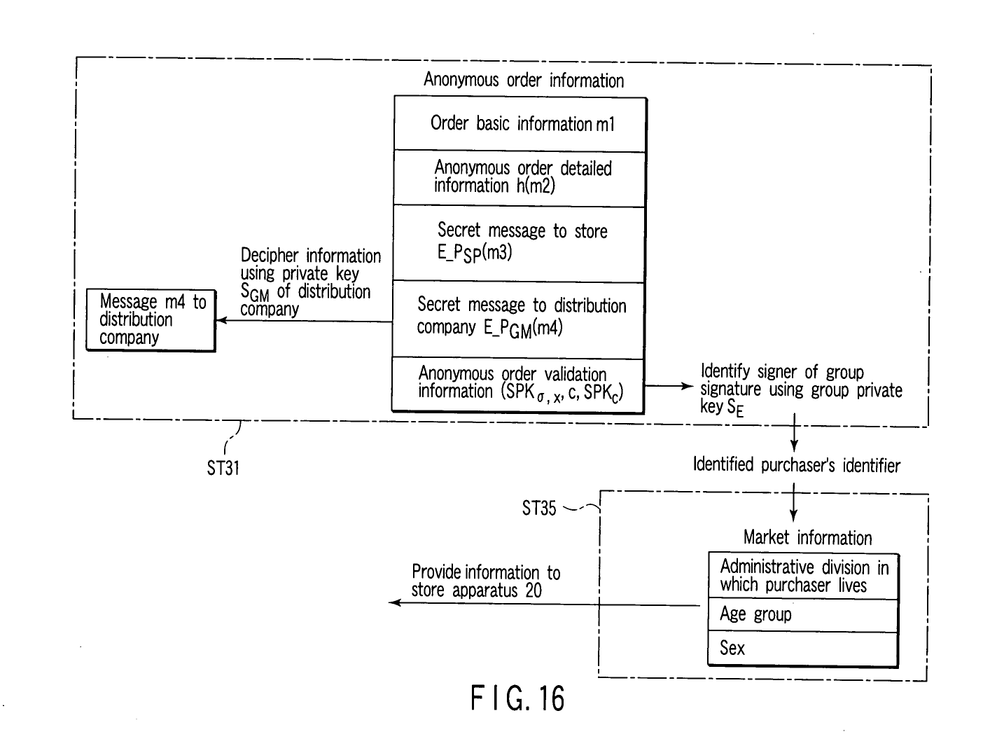

Now, with reference to FIGS. 7 to 16, description will be given of the operation of the anonymous order system configured as described above.

(Initialization: FIGS. 8 to 10)

To start up an anonymous order service (ST1), the distribution company apparatus 10 is operated by an employee in the distribution company to cause the initializing section 12 to set up an anonymous order group to generate pairs of the group public and private keys (P_{G} and S^{G}) and (P_{E} and SE). The initializing section 12 then generates a pair of the distribution company public and private keys (P_{GM} and S_{GM}). The initializing section 12 then writes the group management information consisting of the key pair to the distribution company storage device 11. The distribution company apparatus 10 has only to execute the above process once during the initial service startup. This enables the distribution company apparatus 10 to provide an anonymous order service.

To start providing the anonymous order service, the store apparatus 20 is operated by a store clerk to cause the registration requesting section 22 to transmit the store information and store public key P_{SP} to the distribution company apparatus 10 (ST2).

In the distribution company apparatus 10, the store registering section 13 writes the store registration information including the store information and store public key P_{SP} to the distribution company storage device 11. The store registering section 13 then executes a store registering process (ST3). The store registering section 13 then returns the group public key (P_{G} and P_{E}) stored in the distribution company storage device 11 to the store apparatus 20 (ST4).

In the store apparatus 20, the registration requesting section 22 writes the group public keys (P_{G} and P_{E}) to the store storage device 22 as a part of the order information generation information and anonymous information verification information. The order information generation information and anonymous information verification information also include the pair of the store public and private keys (P_{SP} and S_{SP}). The store apparatus 20 has only to execute the above process during the initial registration in the distribution company.

The purchaser apparatus 30 is operated by the purchaser to cause the registration requesting section 32 to transmit the personal information to the distribution company apparatus 10 (ST4). In the distribution company apparatus 10, the purchaser registering section 14 examines, on the basis of the personal information, whether or not the purchaser is allowed to receive the anonymous order service (ST6). The purchaser registering section 14 then notifies the purchaser apparatus 30 that, for example, the purchaser has passed the examination (ST7).

In the purchaser apparatus 30, on the basis of the notification, the registration requesting section 32 generates a pair of the member public and private keys (P_{A} and S_{A}) for a member of the anonymous order system.

The registration requesting section 32 then writes the key pair to the purchaser storage device 31 (ST8). Subsequently, in the purchaser apparatus 30, the registration requesting section 32 carries out challenge and response authentication with the distribution company apparatus 10 (ST9). During the challenge and response authentication, the member public key P_{A} and the distribution company public key PGM are shared by the purchaser apparatus 30 and distribution company apparatus 10.

Once mutual authentication is completed through the challenge and response in step ST9, the registration requesting section 32 of the purchaser apparatus 30 generates a digital signature Sig_{SA} (P_{A}) and a signature SPK=(e, v) based on a proof of knowledge. The registration requesting section 32 then transmits the digital signature Sig_{SA} (P_{A}) and signature SPK=(e, v) based on a proof of knowledge to the distribution company apparatus 10.

In the distribution company apparatus 10, the purchaser registering section 14 verifies the digital signature Sig_{SA} (P_{A}) and signature SPK=(e, v) based on a proof of knowledge (ST11). Once both signatures are verified to be valid, the purchaser registering section 14 uses the group private key S_{G} to sign the member public key P_{A} to create a member certificate σ_{A} (=Sig_{SG} (P_{A})) (ST12).

Subsequently, the purchaser registering section 14 stores the secret management information consisting of the set (ID_{A}, P_{A}, and σ_{A}) of the member ID, public key, and certificate for the member A, in the tamper-resistant region. The purchaser registering section 14 further adds the pair (P_{A} and Sig_{SA} (P_{A})) of the member public key P_{A} and digital signature to the member list.

Further, the purchaser registering section 14 of the distribution company apparatus 10 transmits the member certificate σ_{A} to the purchaser apparatus 30 (ST14). The registration requesting section 32 of the purchaser apparatus 30 saves the member certificate σ_{A} to the purchaser storage device 31 (ST15). The purchaser apparatus 30 has only to execute the above process during the initial member registration. The purchaser can carry out anonymous orders any number of times utilizing the member private key S_{A} and member certificate σ_{A} generated.

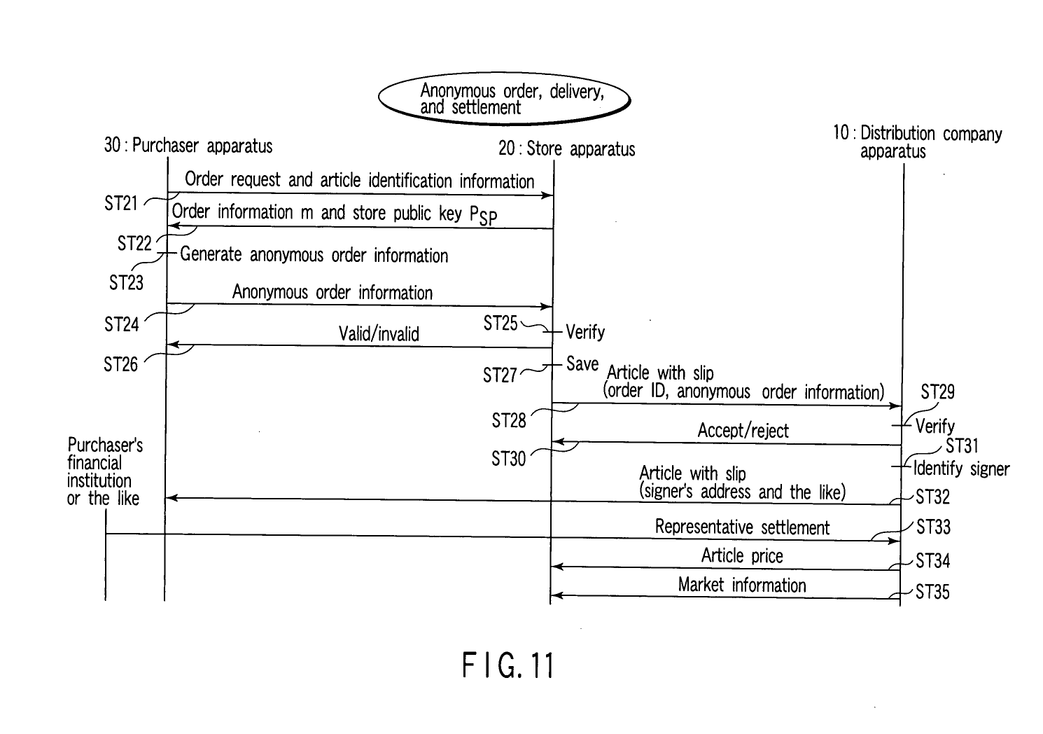

(Anonymous order, Distribution, and Settlement; FIGS. 11 to 16)

The purchaser apparatus 30 is operated by the purchaser to cause the article selecting section 33 to transmit the article identification information and order request to the store apparatus (ST21).

The order information generating section 24 of the store apparatus 20 generates order information m consisting of order basic information m1 and order detailed information m2, from the article identification information on the basis of the order information generation information. The order information generating section 24 then transmits the order information obtained and the store public key P_{SP} to the purchaser apparatus 30 (ST22).

In this case, the order information m is formed of the order basic information m1 and order detailed information m2 connected together (m={m1∥m2}).

The order basic information is the minimum information required for the distribution company to carry out article delivery and settlement. The order basic information includes the order ID, information required to uniquely identify the order. The order detailed information is other detailed information and is desirably kept secret from the distribution company in terms of protection of the purchaser's privacy.

Specific examples of the order basic information m1 and order detailed information m2 are shown below (see FIG. 4).
Order basic information m1=(order ID∥store name∥article category∥total amount payment method)=(m11∥m12∥m13∥m14∥m15)
Order detailed information m2=(article number∥article name∥unit price∥quantity∥order date and time)=(m21∥m22∥m23∥m24∥m25)

The article category m13 indicates a CD, DVD, or the like. The article name m22 indicates the title of the CD, DVD, or the like.

The order confirming section 36 of the purchaser apparatus 30 displays the order basic information m1 and order detailed information m2 on the screen. On the basis of the screen display, the purchaser confirms that the contents of the order are as intended by the purchaser. The purchaser then operates the purchaser apparatus 30. In response to the operation performed by the purchaser, the purchaser apparatus 30 causes the anonymous information generating section 35 to generate anonymous order information from the order basic information m1 and order detailed information m2, on the basis of the anonymous order generation information stored in the purchaser storage device 31 (ST23). The anonymous information generating section 35 transmits the anonymous order information to the store apparatus 20 via the anonymous order section 34 (ST24)

The anonymous order information consists of at least the order basic information m1, the hash value H (m2) for the order detailed information, the secret message E_{P sp} (m3) to the store, the secret message E_{P GM} (m4) to the distribution company, and the group signature (SPK_{σ,x}, c, and SPK_{C}) for the message m (=m1∥H (m2)∥EP_{SP} (m3)∥EP_{GM} (m4)) obtained by connecting the above pieces of information together (see FIG. 6). However, the secret messages EP_{SP} (m3) and EP_{GM} (m4) can be omitted. In the description below, these secret message are omitted.

The group signature (SPK_{σ,x}, c, and SPK_{C}) is calculated from the group public keys (P_{G} and P_{E}) and the purchaser's member private key S_{A} and certificate σ_{A}. Here, a group signature generating function is denoted by GrSig. The anonymous order information is given by the following expression.
Anonymous order information=(m∥GrSig∥(m))=(m1∥H(m2)∥GrSig(m1∥H(m2)))

If the secret messages are not omitted, m1∥H (m2) ∥EP_{SP} (m3)∥EP_{GM} (m4)) may be substituted into m in the above expression. Regardless of whether or not the secret messages are omitted, the group signature is generated as described above. However, the configuration of the message m is different from that in accordance with the prior art.

Upon receiving the anonymous order information, the store apparatus 20 causes the order verifying section 25 to validate the anonymous order information on the basis of the anonymous order verification information stored in the store storage device 21 (ST25). The order verifying section 25 accepts the order only if it can confirm that the hash value H (m2) for the order detailed information has been correctly calculated and that group signature (SPK_{σ,x}, c, and SPK_{C}) is valid (ST26; valid). Otherwise, the order verifying section 25 rejects the order (ST26; invalid).

When the order verifying section 25 accepts the order, the store apparatus 20 saves the order information and the anonymous order information to the store storage device 21 (ST27). Moreover, the store apparatus 20 issues a slip showing the anonymous order information and the order ID described in place of the destination. A store clerk attaches the slip to the packed article for dispatch (ST28). The slip also serves as a request for representative settlement.

In the above anonymous order, the order detailed information m2 in the anonymous order information is kept secret by the hash value H (m2). Consequently, what the purchaser has bought can be kept secret to guard the purchaser's privacy relating to the contents of the order.

A major characteristic of the anonymous order is that none of the personal information on the purchaser, including a fictitious name or ID, is sent after a request is made for the start of an order procedure and before the order is accepted, with no accesses made to the distribution company.

Now, article delivery and settlement will be described.

The distribution company delivers the article for which the store has accepted the order and settles accounts. The distribution company apparatus 10 saves the information on the previously received anonymous orders in the distribution company storage device 11 as an order history list in order to prevent the store from making an invalid request.

Upon receiving the anonymous order information from the store, the distribution company apparatus 10 causes the order verifying section 16 to check whether or not the same information is contained in the order history list. If the same information is found, the order verifying section 16 determines the request to be invalid and rejects article delivery and settlement. If the same information is not found, the order verifying section 16 validates the group signature contained in the anonymous order information (ST29).

The order verifying section 16 also rejects article delivery and settlement if the signature is invalid (ST30; reject). The order verifying section 16 accepts the request only if the signature is verified to be valid (ST30; accept). The order verifying section 16 then adds the anonymous order information to the order history list to save it to the distribution company storage device 11. The distribution company thus prevents the store from making an invalid request.

Subsequently, the purchaser identifying section 17 of the distribution company apparatus 10 uses the group private key S_{E} to decipher the group signature c (=E_{P E} (P A)). The purchaser identifying section 17 uses the member public key P_{A} obtained to identify the signer with reference to the member list (ST31). The purchaser identifying section 17 then displays the identified contents such as the address and name on the screen or issues an attachment seal showing the identified contents (address information output means).

An employee in the distribution company enters the information on the identified purchaser in the slip for the corresponding article and delivers the article (ST32; external delivery means). The process of identifying the purchaser can be executed only by the distribution company apparatus 10, the only apparatus having the group management information and the member personal information. Further, in the distribution company apparatus 10, the settlement processing section 15 settles the purchaser's account in a financial institution on the purchaser's behalf on the basis of the member personal information described in the member list in the distribution company storage device 11 (ST33). The settlement processing section 15 then pays the price of the article to the store (its financial institution or the like) (ST34). Moreover, in the distribution company apparatus 10, the market information generating section 18 deletes information that enables the individual to be identified (for example, the address and name), from the information on the identified signer. The market information generating section 18 thus generates market information consisting of, for example, an administrative division, an age group, and the sex. The market information generating section 18 then transmits the market information to the store apparatus 20 (ST35). The store apparatus 20 saves the market information so that it is available for various analyses.

As described above, according to the present embodiment, upon receiving anonymous order information including an order ID and a group signature from the purchaser apparatus 30, the store apparatus 20 verifies the group signature. If the group signature is verified to be valid, the store apparatus 20 transmits the anonymous order information and the article corresponding to the order ID, to the distribution company apparatus 10 with the article name kept secret. On the basis of the anonymous order information, the manager apparatus 10 uses the tracing function to identify the corresponding personal information stored in the storage device 10, on the basis of the member public key P_{A} obtained by deciphering the group signature. The manager apparatus 10 then outputs the personal information by displaying it on the screen or issuing the corresponding seal for the external delivery means (employee in the distribution company) to deliver. The employee in the distribution company delivers the sales target to the purchaser on the basis of the personal information.

Consequently, the store apparatus 20, serving as a service provider, need not manage the personal information. This enables the user to remain anonymous. Further, since the distribution company apparatus 10 handles the anonymous order information, the privacy of the contents of the order can be protected from the distribution company apparatus 10.

That is, when the conventional group signature system is simply applied to online storeping, the contents of the order are known to the manager apparatus 10. This precludes the protection of privacy. However, the present embodiment uses the order detailed information H (m2) in which the contents of the order are kept secret. This enables the protection of privacy.

A supplementary description will be given. Only the purchaser knows who has placed the order and what has been ordered. The order is completed only by the interaction between the purchaser and the store. The store knows what has been ordered but not who has placed the order. The distribution company knows who has placed the order but not what has been ordered (except for the article category). A further supplementary description will be given. Even though the anonymous order does not indicate who has placed the order, the store can obtain market information on the order which is required for various analyses.

Subsequently, the effects of the present embodiment will be described in brief. Specifically, a conventional online service order (general order) will be compared with an online service order (anonymous order) utilizing the anonymous order system. Advantages will then be described for each of the characters in the system, the purchaser (service user), store (service provider), and distribution company (personal information managing organization).

(Advantages to the Purchaser A)

(A1: Anonymous Order is Available)

For conventional general orders, the purchaser must pass the personal information to each store, which must then manage the information. Further, the personal information is generally registered in a settlement company such as a credit card company in order to settle the purchaser's account. That is, the purchaser's personal information is managed in a large number of places. If any party carelessly managed the information, the personal information might leak. It is difficult for the purchaser to understand the security polices of all the stores utilized by the purchaser to know whether or not the personal information is appropriately managed. Accordingly, the personal information is likely to leak. In fact, a large number of service users are unwilling to pass their personal information to the store. A survey conducted by RSA Security Inc. in U.S. shows that 44% of the users are unwilling to provide their personal information in receiving service.

In contrast, the anonymous order does not require any personal information to be passed to the store; the personal information has only to be entrusted to the distribution company. The purchaser can safely place an order with any store provided that he or she can trust the distribution company in terms of its security policy and management of personal information.

(A2: Privacy of an Order is Guarded)

The conventional general order allows the store to determine who has placed the order and what has been ordered.

In contrast, the anonymous order in accordance with the present embodiment allows the store to know only what has been ordered, while allowing the distribution company to know only who has placed the order. This makes it possible to guard the purchaser's privacy relating to the contents of the order.

(A3: Order Procedure is Simplified)

A known conventional method for general orders utilizes Cookie or the like to omit the input of personal information, thus simplifying the procedure of placing an order. However, this is limited to the second and subsequent orders placed with the same service provider; personal information must be input for the first order.

In contrast, the anonymous order in accordance with the present embodiment does not require any personal information to be input regardless of whether the purchaser is placing the first order or the second or subsequent order. This simplifies the procedure of placing an order.

(Advantages to the Store SP)

(SP1: Costs and Risks of Personal Information Management are Eliminated)

The conventional general order requires personal information to be managed in order to accept an order. However, stricter personal information management is demanded as a result of the successive leakages of personal information and the enforcement of the Personal Information Protection Law. This results in a continuous increase in management costs. Further, if personal information leaked out, public trust would be lost; personal information management involves immeasurable risks.

In contrast, the anonymous order in accordance with the present embodiment allows orders to be accepted without handling personal information. This makes possible to eliminate the costs and risks.

(SP2: Potential Demand is Attracted to The Anonymous Order)

As described for the advantages to the purchaser, a large number of purchasers are unwilling to pass their personal information, in particular, to the store with which they place an order for the first time. A survey shows that the estimated amount of interrupted online transactions in 2004 is 6.3 million dollars. It is very advantageous to the store to attract this potential demand or even part of it to the anonymous order.

(SP3: Market Information is Acquired without the Need to Manage Personal Information)

With the conventional general order, each store manages personal information and can thus acquire detailed market information.

In contrast, the anonymous order in accordance with the present embodiment does not allow the direct acquisition of market information similar to that obtained in the case of the general order. However, market information can be acquired through the distribution company.

(Advantage for the Distribution Company GM)

(1: Existing Personal Information can be Utilized)

As previously described, management of personal information involves high costs and risks.

Accordingly, managed personal information is desirably utilized effectively.

The distribution company can utilize the anonymous order system to provide new services. The demand for the anonymous order is as described for the advantages to the purchaser and store. The anonymous order system is expected to effectively utilize personal information.

### Second Embodiment

Now, description will be given of an anonymous order system in accordance with a second embodiment of the present invention.

The present invention is a variation of the first embodiment. In the present embodiment, the purchaser specifies an address different from the purchaser's as the destination of an article as in the case of a present.

Specifically, the present embodiment is almost similar to the first embodiment except that, as shown in FIG. 6, the distribution company public key P_{GM} is used to cipher a message m4 indicating the destination of a present to obtain a secrete message E_{P GM} (m 4) to the distribution company, which is then contained in the anonymous order information. It is also possible to add a flag indicating whether or not the article is a present, to the anonymous order information.

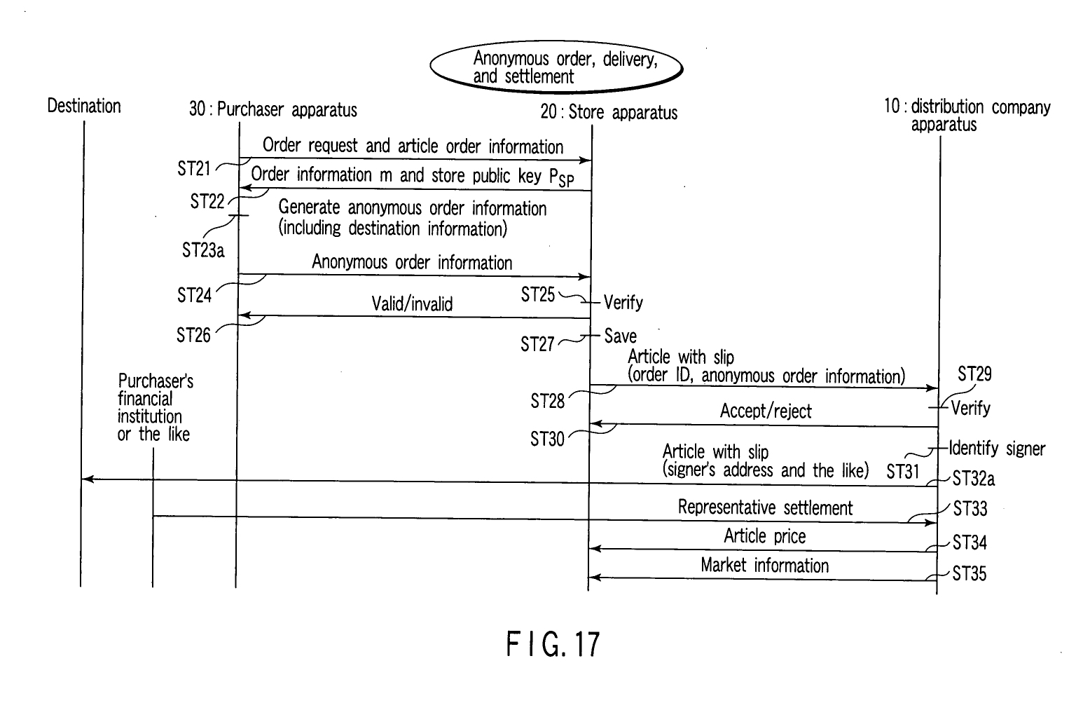

With the above configuration, as shown in FIG. 17, in step ST23a, anonymous order information is generated which includes the secret message E_{P GM} (m 4). In step ST32a, the article is delivered to the destination. The other operations are as previously described.

Consequently, the present invention not only produces the effects of the first embodiment but also enables the purchaser to specify an address different from the purchaser's as the destination of the article.

### Third Embodiment

Now, description will be given of an anonymous order system in accordance with a third embodiment of the present invention.

The present embodiment is a variation of the first embodiment in which the article is a digital content. Accordingly, the system comprises, instead of the distribution company apparatus 10, a credit company apparatus 10′ configured similarly to the distribution company apparatus 10.

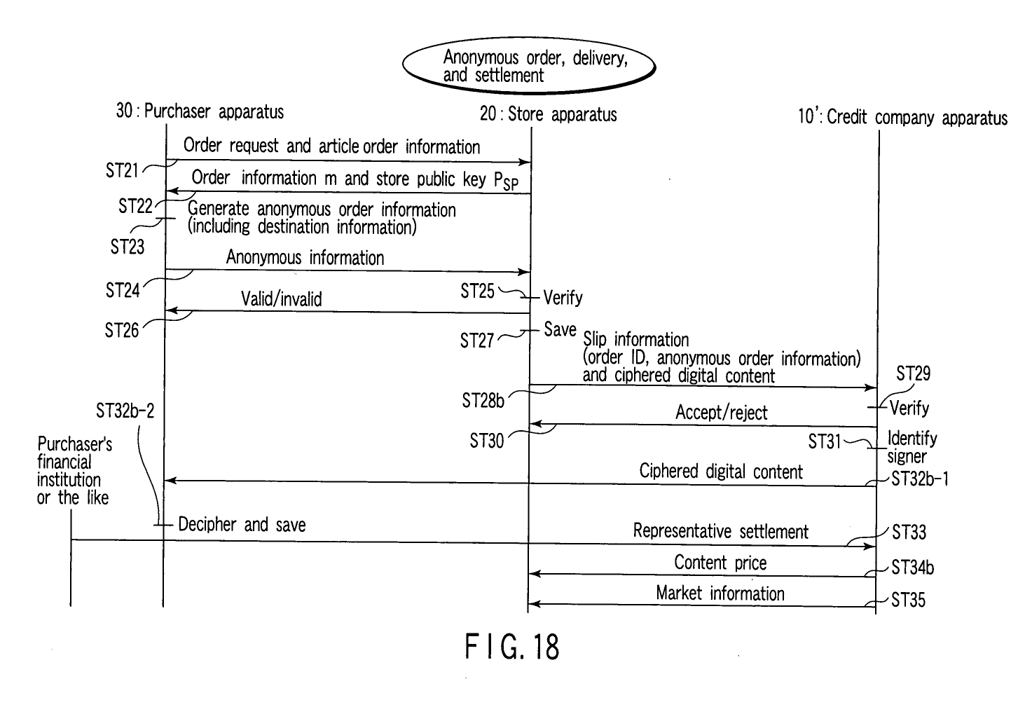

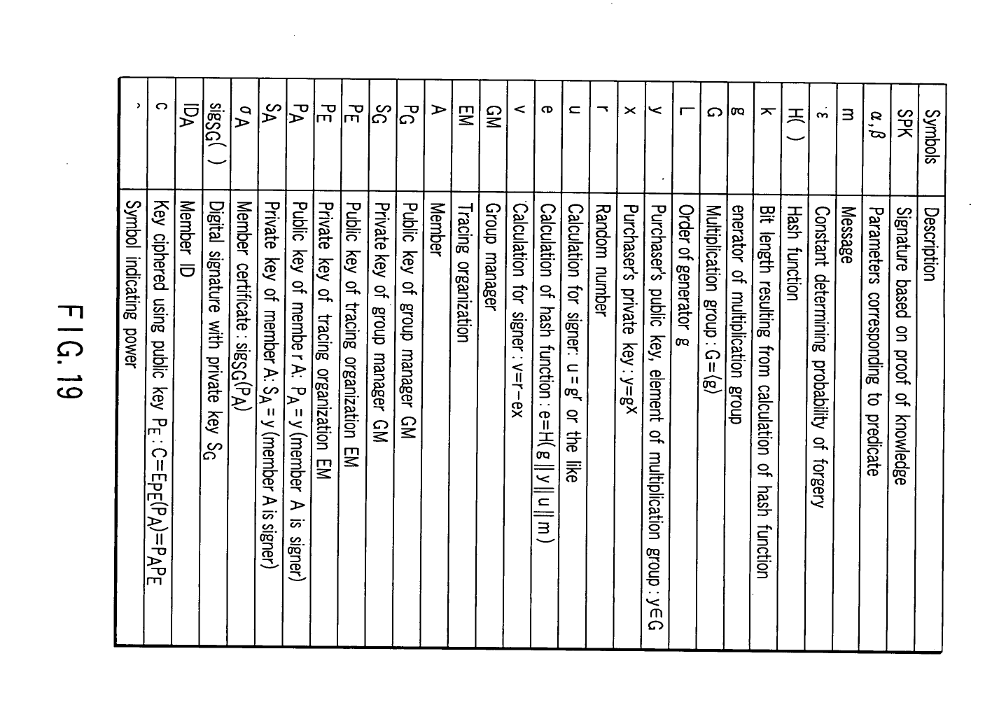

With this configuration, as shown in FIG. 18, in step ST28b, the store apparatus 20 transmits a ciphered digital content to the credit company apparatus 10′. In step ST32b-1 (address output means and providing means), the ciphered digital content is transmitted to the purchaser apparatus 30 on the basis of network address information on the purchaser identified in ST31, the information having been read from the storage device 11 as personal information on the purchaser. The ciphered digital content has been obtained by using the purchaser's member public key P_{A}. Further, in step ST32b-2, the ciphered digital content is deciphered using the member private key S_{A}. Deciphered digital content is then saved to the purchaser storage device 11. The other operations are as previously described.

Consequently, the present embodiment produces effects similar to those of the first embodiment even though the article is a digital content. Further, the present embodiment is applicable to the second embodiment so that the ciphered digital content can be transmitted to the address of a destination different from the purchaser apparatus 30. Further, the present embodiment may be varied so that the ciphered digital content in step ST28b in FIG. 18 as well as step ST32b-1 are omitted and so that, in step ST26, the store apparatus 20 transmits a ciphered digital content to the purchaser apparatus 30 instead of the validity message. This variation enables the ciphered digital content to be transmitted without using the credit card apparatus 10′. It is thus possible to provide the digital content to the purchaser promptly.

The technique described above in each embodiment can be stored in storage media such as a magnetic disk (floppy disk, hard disk, or the like), an optical disk (CD-ROM, DVD, or the like), a magneto-optical disk (MO), or a semiconductor memory so as to be distributed as a program that can be executed by a computer.

The storage media may have any storage form provided that it can store programs and is readable by a computer.

A process for carrying out the present invention may be partly executed by an operating system (OS) operating on a computer on the basis of instructions from a program obtained from storage media and installed in a computer, or middle ware such as database managing software or network software.

Moreover, the storage media in the present invention is not limited to media independent of the computer. The storage media may store or temporarily store a program transmitted through LAN, the Internet, or the like.

Further, the present invention is not limited to single storage media but the process in accordance with the present embodiment may be executed using a plurality of storage media. Any media configuration may be used.

The computer in accordance with the present invention executes each process in accordance with the present embodiment on the basis of a program stored in the storage media. The computer may be a single apparatus consisting of a personal computer or the like or a system having a plurality of apparatuses connected together through a network.

Furthermore, the computer in accordance with the present invention is not limited to the personal computer. The computer may be an arithmetic processing device, a microcomputer, or the like included in an information processing apparatus. The computer is a general term for apparatuses that can implement the functions of the present invention using a program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An anonymous order system which uses a group signature system having a tracing function to execute an anonymous order for a sales target comprising an article or service and sale of the sales target in accordance with the anonymous order, the system comprising:
a manager apparatus which stores, in a storage device, personal information and group signature related information on a purchaser who places the anonymous order and which, on the basis of anonymous order information received from a store and including an order ID and a group signature, uses the tracing function to identify a corresponding part of the personal information stored in the storage device, on the basis of group signature related information obtained by deciphering the group signature, the manager apparatus then outputting the personal information obtained by the identification so as to allow an external delivery section to carry out delivery;
a store apparatus which issues an order ID to a purchaser apparatus of the purchaser and which, upon receiving anonymous order information including the order ID and a group signature from the purchaser apparatus, verifies the group signature and when the group signature is verified to be valid, transmits the anonymous order information to the manager apparatus; and
the purchaser apparatus which, upon receiving the order ID from the store apparatus, is operated by the purchaser to generate anonymous order information including the order ID and a group signature and transmitting the anonymous order information obtained to the store apparatus.

2. An anonymous order system which uses a group signature system having a tracing function to execute an anonymous order for a sales target comprising an article or service and sale of the sales target in accordance with the anonymous order, the system comprising:
a manager apparatus which manages a purchaser who places the anonymous order, as a member of the group signature system and which, on the basis of anonymous order information received from a store and including an order ID and a group signature, uses the tracing function to identify the purchaser on the basis of the group signature, the manager apparatus then outputting personal information on the purchaser so as to allow an external delivery section to carry out delivery;
a store apparatus which issues an order ID to a purchaser apparatus of the purchaser and which, upon receiving anonymous order information including the order ID and a group signature from the purchaser apparatus, verifies the group signature and when the group signature is verified to be valid, transmits the anonymous order information to the manager apparatus; and
the purchaser apparatus which, upon receiving the order ID from the store apparatus, is operated by the purchaser to generate anonymous order information including the order ID and a group signature and transmitting the anonymous order information obtained to the store apparatus.

3. A store apparatus used in an anonymous order system which uses a group signature system having a tracing function to execute an anonymous order for a sales target comprising an article or service and sale of the sales target in accordance with the anonymous order, the store apparatus being able to communicate with both a purchase apparatus of a purchaser who places the anonymous order and a manager apparatus using the group managing system to manage the purchaser, the store apparatus comprising:
an order information generating section which, on the basis of sales target identification information received from the purchaser apparatus, generates order information including an order ID and which transmits the order information to the purchaser apparatus;
a signature verifying section which, upon receiving anonymous order information including the order ID and a group signature from the purchaser apparatus, verifies the group signature; and
a transmitting section which, when the group signature is verified to be valid, transmits the anonymous order information to the manager apparatus.

4. A purchaser apparatus used in an anonymous order system which uses a group signature system having a tracing function to execute an anonymous order for a sales target comprising an article or service and sale of the sales target in accordance with the anonymous order, the purchaser apparatus being able to communicate with both:
a manager apparatus which manages a purchaser who places the anonymous order, as a member of the group signature system and which, on the basis of anonymous order information received from a store and including an order ID and a group signature, uses the tracing function to identify the purchaser on the basis of the group signature, the manager apparatus then outputting personal information on the purchaser so as to allow an external delivery section to carry out delivery and
a store apparatus which issues an order ID to a purchaser apparatus of the purchaser and which, upon receiving anonymous order information including the order ID and a group signature from the purchaser apparatus, verifies the group signature and when the group signature is verified to be valid, transmits the anonymous order information to the manager apparatus, the purchaser apparatus comprising:
a target information transmitting section which transmits sales target identification information to the store apparatus in response to an operation performed by the purchaser;
an anonymous information generating section which, upon receiving an order ID from the store apparatus in response to the transmission, generates anonymous order information including the order ID and a group signature; and
an anonymous information transmitting section which transmits the anonymous order information to the store apparatus.

5. The purchaser apparatus according to claim 4, wherein the anonymous information generating section comprises:
a basic information generating section which generates order basic information including the order ID but not including the sales target identification information;
a detailed information generating section which generates order detailed information in which the sales target identification information is kept secret;
a group signature generating section which generates the group signature using the group signature system; and
an editing section which edits a message portion containing at least the order basic information and the order detailed information as well as the group signature to obtain the anonymous order information.

6. The purchaser apparatus according to claim 5, further comprising a first secret message generating section which uses a pubic key of the manager apparatus to cipher a message to the manager apparatus to keep the message secret, thus generating a manager secret message,
wherein the editing section contains the manager secret message in the message portion.

7. The purchaser apparatus according to claim 6, wherein the message to the manager apparatus contains information on a destination different from the purchaser.

8. The purchaser apparatus according to any of claims 5 to 7, further comprising a second secret message generating section which uses a pubic key of the store apparatus to cipher a message to the store to keep the message secret, thus generating a store secret message,
wherein the editing section contains the store secret message in the message portion.

9. A purchaser apparatus used in an anonymous order system which uses a group signature system having a tracing function to execute an anonymous order for a sales target comprising an article or service and sale and provision of the sales target in accordance with the anonymous order, the purchaser apparatus being able to communicate with both:
a manager apparatus which manages a purchaser who places the anonymous order as a member of the group signature system and which, upon receiving anonymous order information including an order ID and a group signature, uses the tracing function to identify the purchaser on the basis of the group signature and
a store apparatus which issues an order ID to a purchaser apparatus of the purchaser and which, upon receiving anonymous order information including the order ID and a group signature from the purchaser apparatus, verifies the group signature and when the purchaser the group signature is verified to be valid, sells the purchaser the sales target corresponding to the order ID, the purchaser apparatus comprising:
a target information transmitting section which transmits sales target identification information to the store apparatus in response to an operation preformed by the purchaser;
a basic information generating section which, upon receiving an order ID from the store apparatus in response to the transmission, generates order basic information including the order ID but not including the sales target identification information;
a detailed information generating section which generates order detailed information in which the sales target identification information is kept secret;
a group signature generating section which generates the group signature using the group signature system;
an editing section which edits a message portion containing at least the order basic information and the order detailed information as well as the group signature to obtain the anonymous order information; and
an anonymous information transmitting section which transmits the anonymous order information obtained by the editing section to the store apparatus.

10. A purchaser apparatus used in an anonymous order system which uses a group signature system having a tracing function to execute an anonymous order for a sales target comprising an article or service and sale and provision of the sales target in accordance with the anonymous order, the purchaser apparatus being able to communicate with both:
a manager apparatus which manages a purchaser who places the anonymous order as a member of the group signature system and which, upon receiving anonymous order information including an order ID and a group signature, uses the tracing function to identify the purchaser on the basis of the group signature and
a store apparatus which issues an order ID to a purchaser apparatus of the purchaser and which, upon receiving anonymous order information including the order ID and a group signature from the purchaser apparatus, verifies the group signature and when the group signature is verified to be valid, sells the purchaser the sales target corresponding to the order ID, the purchaser apparatus comprising:
a target information transmitting section which transmits sales target identification information to the store apparatus in response to an operation preformed by the purchaser;
a basic information generating section which, upon receiving an order ID from the store apparatus in response to the transmission, generates order basic information including the order ID but not including the sales target identification information;
a detailed information generating section which generates order detailed information in which the sales target identification information is kept secret;
a manager secret message generating section which uses a pubic key of the manager apparatus to cipher a message to the manager apparatus to keep the message secret, thus generating a manager secret message,
a group signature generating section which generates the group signature using the group signature system;
an editing section which edits a message portion containing at least the order basic information, the order detailed information, and the manager secret message as well as the group signature to obtain the anonymous order information; and
an anonymous information transmitting section which transmits the anonymous order information obtained by the editing section to the store apparatus.

11. A purchaser apparatus used in an anonymous order system which uses a group signature system having a tracing function to execute an anonymous order for a sales target comprising an article or service and sale and provision of the sales target in accordance with the anonymous order, the purchaser apparatus being able to communicate with both:
a manager apparatus which manages a purchaser who places the anonymous order as a member of the group signature system and which, upon receiving anonymous order information including an order ID and a group signature, uses the tracing function to identify the purchaser on the basis of the group signature and
a store apparatus which issues an order ID to a purchaser apparatus of the purchaser and which, upon receiving anonymous order information including the order ID and a group signature from the purchaser apparatus, verifies the group signature and when the group signature is verified to be valid, sells the purchaser the sales target corresponding to the order ID, the purchaser apparatus comprising:
a target information transmitting section which transmits sales target identification information to the store apparatus in response to an operation preformed by the purchaser;
a basic information generating section which, upon receiving an order ID from the store apparatus in response to the transmission, generates order basic information including the order ID but not including the sales target identification information;
a detailed information generating section which generates order detailed information in which the sales target identification information is kept secret;
a manager secret message generating section which uses a pubic key of the manager apparatus to cipher a message to the manager apparatus which contains information on a destination different from the purchaser to keep the message secret, thus generating a manager secret message,
a group signature generating section which generates the group signature using the group signature system;
an editing section which edits a message portion containing at least the order basic information, the order detailed information, and the manager secret message as well as the group signature to obtain the anonymous order information; and
an anonymous information transmitting section which transmits the anonymous order information obtained by the editing section to the store apparatus.

12. A purchaser apparatus used in an anonymous order system which uses a group signature system having a tracing function to execute an anonymous order for a sales target comprising an article or service and sale and provision of the sales target in accordance with the anonymous order, the purchaser apparatus being able to communicate with both:
a manager apparatus which manages a purchaser who places the anonymous order as a member of the group signature system and which, upon receiving anonymous order information including an order ID and a group signature, uses the tracing function to identify the purchaser on the basis of the group signature and
a store apparatus which issues an order ID to a purchaser apparatus of the purchaser and which, upon receiving anonymous order information including the order ID and a group signature from the purchaser apparatus, verifies the group signature and when the group signature is verified to be valid, sells the purchaser the sales target corresponding to the target ID, the purchaser apparatus comprising:
a target information transmitting section which transmits sales target identification information to the store apparatus in response to an operation preformed by the purchaser;
a basic information generating section which, upon receiving an order ID from the store apparatus in response to the transmission, generates order basic information including the order ID but not including the sales target identification information;
a detailed information generating section which generates order detailed information in which the sales target identification information is kept secret;
a store secret message generating section which uses a pubic key of the store apparatus to cipher a message to the store apparatus to keep the message secret, thus generating a store secret message,
a group signature generating section which generates the group signature using the group signature system;
an editing section which edits a message portion containing at least the order basic information, the order detailed information, and the store secret message as well as the group signature to obtain the anonymous order information; and
an anonymous information transmitting section which transmits the anonymous order information obtained by the editing section to the store apparatus.

13. A manager apparatus used in an anonymous order system which uses a group signature system having a tracing function to execute an anonymous order for a sales target comprising an article or service and sale and provision of the sales target in accordance with the anonymous order, the manager apparatus being able to communicate with both a purchaser apparatus of a purchaser who places the anonymous order and a store apparatus of a store which carries out the sale, the manager apparatus managing the purchaser as a member of the group signature system, the manager apparatus comprising:
a purchaser identifying section which, upon receiving the sales target for which a name of the sales target is kept secret from the store or store apparatus as well as anonymous order information including an order ID and a group signature, identifies the purchaser on the basis of the group signature using the tracing function; and
an address output section which outputs address information or network address information on the identified purchaser to a providing section which provides the purchaser with the sales target.

14. A manager apparatus used in an anonymous order system which uses a group signature system having a tracing function to execute an anonymous order for a sales target comprising an article or service and sale and provision of the sales target in accordance with the anonymous order, the manager apparatus being able to communicate with both a purchaser apparatus of a purchaser who places the anonymous order and a store apparatus of a store which carries out the sale and storing personal information and group signature related information on the purchaser in a storage device for management, the manager apparatus comprising:
a purchaser identifying section which, upon receiving anonymous order information including an order ID and a group signature, identifies the personal information on the corresponding purchaser stored in the storage device, on the basis of group signature related information obtained by deciphering the group signature using the tracing function;
a market information generating section which deletes information which enables the individual to be identified, from the personal information obtained by the identification to generate market information; and
a market information transmitting section which transmits the market information obtained to the store apparatus.

15. A program for a store apparatus used in an anonymous order system which uses a group signature system having a tracing function to execute an anonymous order for a sales target comprising an article or service and sale of the sales target in accordance with the anonymous order, the store apparatus being able to communicate with both a purchase apparatus of a purchaser who places the anonymous order and a manager apparatus using the group managing system to manage the purchaser, the program allowing a computer in the store apparatus to function as:
order information generating means for, on the basis of sales target identification information received from the purchaser apparatus, generating order information including an order ID and transmitting the order information to the purchaser apparatus;
signature verifying means for, upon receiving anonymous order information including the order ID and a group signature from the purchaser apparatus, verifies the group signature; and
transmission means for, when the group signature is verified to be valid, transmitting the anonymous order information to the manager apparatus.

16. A program for a purchaser apparatus used in an anonymous order system which uses a group signature system having a tracing function to execute an anonymous order for a sales target comprising an article or service and sale of the sales target in accordance with the anonymous order, the purchaser apparatus being able to communicate with both:
a manager apparatus which manages a purchaser who places the anonymous order, as a member of the group signature system and which, on the basis of anonymous order information received from a store and including an order ID and a group signature, uses the tracing function to identify the purchaser on the basis of the group signature, the manager apparatus then outputting personal information on the purchaser so as to allow an external delivery means to carry out delivery and
a store apparatus which issues an order ID to a purchaser apparatus of the purchaser and which, upon receiving anonymous order information including the order ID and a group signature from the purchaser apparatus, verifies the group signature and when the group signature is verified to be valid, transmits the anonymous order information to the manager apparatus, the program allowing a computer in the purchaser apparatus to function as:
target information transmitting means for transmitting sales target identification information to the store apparatus in response to an operation performed by the purchaser;
anonymous information generating means for, upon receiving an order ID from the store apparatus in response to the transmission, generating anonymous order information including the order ID and a group signature on the basis of a member private key and a member certificate stored in a memory; and
anonymous information transmitting means for transmitting the anonymous order information to the store apparatus.

17. The program according to claim 16, wherein the anonymous information generating means comprises:
basic information generating means for generating order basic information including the order ID but not including the sales target identification information;
detailed information generating means for generating order detailed information in which the sales target identification information is kept secret;
group signature generating means for generating the group signature using the group signature system; and
editing means for editing a message portion containing at least the order basic information and the order detailed information as well as the group signature to obtain the anonymous order information.

18. The program according to claim 17, further allowing the computer in the purchaser apparatus to function as:
first secret message generating means for ciphering a message to the manager apparatus using a pubic key of the manager apparatus to keep the message secret, thus generating a manager secret message,
wherein the editing means contains the manager secret message in the message portion.

19. The program according to claim 18, wherein the message to the manager apparatus contains information on a destination different from the purchaser.

20. The program according to any of claims 17 to 19, further allowing the computer in the purchaser apparatus to function as:
second secret message generating means for cipher a message to the store using a pubic key of the store apparatus to keep the message secret, thus generating a store secret message,
wherein the editing means contains the store secret message in the message portion.

21. A program for a purchaser apparatus used in an anonymous order system which uses a group signature system having a tracing function to execute an anonymous order for a sales target comprising an article or service and sale and provision of the sales target in accordance with the anonymous order, the purchaser apparatus being able to communicate with both:
a manager apparatus which manages a purchaser who places the anonymous order as a member of the group signature system and which, upon receiving anonymous order information including an order ID and a group signature, uses the tracing function to identify the purchaser on the basis of the group signature and
a store apparatus which issues an order ID to a purchaser apparatus of the purchaser and which, upon receiving anonymous order information including the order ID and a group signature from the purchaser apparatus, verifies the group signature and when the group signature is verified to be valid, sells the purchaser the sales target corresponding to the order ID, the program allowing a computer in the purchaser apparatus to function as:
target information transmitting means for transmitting sales target identification information to the store apparatus in response to an operation preformed by the purchaser;
basic information generating means for, upon receiving an order ID from the store apparatus in response to the transmission, generating order basic information including the order ID but not including the sales target identification information;
detailed information generating means for generating order detailed information in which the sales target identification information is kept secret;
group signature generating means for generating the group signature using the group signature system;
editing means for editing a message portion containing at least the order basic information and the order detailed information as well as the group signature to obtain the anonymous order information; and
anonymous information transmitting means for transmitting the anonymous order information obtained by the editing means to the store apparatus.

22. A program for a purchaser apparatus used in an anonymous order system which uses a group signature system having a tracing function to execute an anonymous order for a sales target comprising an article or service and sale and provision of the sales target in accordance with the anonymous order, the purchaser apparatus being able to communicate with both:
a manager apparatus which manages a purchaser who places the anonymous order as a member of the group signature system and which, upon receiving anonymous order information including an order ID and a group signature, uses the tracing function to identify the purchaser on the basis of the group signature and
a store apparatus which issues an order ID to a purchaser apparatus of the purchaser and which, upon receiving anonymous order information including the order ID and a group signature from the purchaser apparatus, verifies the group signature and when the group signature is verified to be valid, sells the purchaser the sales target corresponding to the order ID, the program allowing a computer in the purchaser apparatus to function as:
target information transmitting means for transmitting sales target identification information to the store apparatus in response to an operation preformed by the purchaser;
basic information generating means for, upon receiving an order ID from the store apparatus in response to the transmission, generating order basic information including the order ID but not including the sales target identification information;
detailed information generating means for generating order detailed information in which the sales target identification information is kept secret;
manager secret message generating means for cipher a message to the manager apparatus using a pubic key of the manager apparatus to keep the message secret, thus generating a manager secret message,
group signature generating means for generating the group signature using the group signature system;
editing means for editing a message portion containing at least the order basic information, the order detailed information, and the manager secret message as well as the group signature to obtain the anonymous order information; and
anonymous information transmitting means for transmitting the anonymous order information obtained by the editing means to the store apparatus.

23. A program for a purchaser apparatus used in an anonymous order system which uses a group signature system having a tracing function to execute an anonymous order for a sales target comprising an article or service and sale and provision of the sales target in accordance with the anonymous order, the purchaser apparatus being able to communicate with both:
a manager apparatus which manages a purchaser who places the anonymous order as a member of the group signature system and which, upon receiving anonymous order information including an order ID and a group signature, uses the tracing function to identify the purchaser on the basis of the group signature and
a store apparatus which issues an order ID to a purchaser apparatus of the purchaser and which, upon receiving anonymous order information including the order ID and a group signature from the purchaser apparatus, verifies the group signature and when the group signature is verified to be valid, sells the purchaser the sales target corresponding to the order ID, the program allowing a computer in the purchaser apparatus to function as:
target information transmitting means for transmitting sales target identification information to the store apparatus in response to an operation preformed by the purchaser;
basic information generating means for, upon receiving an order ID from the store apparatus in response to the transmission, generating order basic information including the order ID but not including the sales target identification information;
detailed information generating means for generating order detailed information in which the sales target identification information is kept secret;
manager secret message generating means for ciphering a message to the manager apparatus which contains information on a destination different from the purchaser, using a pubic key of the manager apparatus, to keep the message secret, thus generating a manager secret message,
group signature generating means for generating the group signature using the group signature system;
editing means for editing a message portion containing at least the order basic information, the order detailed information, and the manager secret message as well as the group signature to obtain the anonymous order information; and
anonymous information transmitting means for transmitting the anonymous order information obtained by the editing means to the store apparatus.

24. A program for a purchaser apparatus used in an anonymous order system which uses a group signature system having a tracing function to execute an anonymous order for a sales target comprising an article or service and sale and provision of the sales target in accordance with the anonymous order, the purchaser apparatus being able to communicate with both:
a manager apparatus which manages a purchaser who places the anonymous order as a member of the group signature system and which, upon receiving anonymous order information including an order ID and a group signature, uses the tracing function to identify the purchaser on the basis of the group signature and
a store apparatus which issues an order ID to a purchaser apparatus of the purchaser and which, upon receiving anonymous order information including the order ID and a group signature from the purchaser apparatus, verifies the group signature and when the group signature is verified to be valid, sells the purchaser the sales target corresponding to the order ID, the program allowing a computer in the purchaser apparatus to function as:
target information transmitting means for transmitting sales target identification information to the store apparatus in response to an operation preformed by the purchaser;
basic information generating means for, upon receiving an order ID from the store apparatus in response to the transmission, generating order basic information including the order ID but not including the sales target identification information;
detailed information generating means for generating order detailed information in which the sales target identification information is kept secret;
store secret message generating means for ciphering a message to the store apparatus using a pubic key of the store apparatus to keep the message secret, thus generating a store secret message,
group signature generating means for generating the group signature using the group signature system;
editing means for editing a message portion containing at least the order basic information, the order detailed information, and the store secret message as well as the group signature to obtain the anonymous order information; and
anonymous information transmitting means for transmitting the anonymous order information obtained by the editing means to the store apparatus.

25. A program for a manager apparatus used in an anonymous order system which uses a group signature system having a tracing function to execute an anonymous order for a sales target comprising an article or service and sale and provision of the sales target in accordance with the anonymous order, the manager apparatus being able to communicate with both a purchaser apparatus of a purchaser who places the anonymous order and a store apparatus of a store which carries out the sale, the manager apparatus managing the purchaser as a member of the group signature system, the program allowing a computer in the manager apparatus to function as:
purchaser identifying means for, upon receiving the sales target for which a name of the sales target is kept secret from the store or store apparatus as well as anonymous order information including an order ID and a group signature, identifying the purchaser by deciphering the group signature using the tracing function on the basis of a group private key stored in a memory; and
address output means for outputting address information or network address information on the identified purchaser to a providing means for provides the purchaser with the sales target.

26. A program for a manager apparatus used in an anonymous order system which uses a group signature system having a tracing function to execute an anonymous order for a sales target comprising an article or service and sale and provision of the sales target in accordance with the anonymous order, the manager apparatus being able to communicate with both a purchaser apparatus of a purchaser who places the anonymous order and a store apparatus of a store which carries out the sale and storing personal information and group signature related information on the purchaser in a storage device for management, the program allowing a computer in the manager apparatus to function as:
purchaser identifying means for, upon receiving the sales target for which a name of the sales target is kept secret from the store or store apparatus as well as anonymous order information including an order ID and a group signature, identifying the personal information on the corresponding purchaser stored in the storage device, on the basis of group signature related information obtained by deciphering the group signature using the tracing function;
address output means for outputting address information or network address information on the purchaser corresponding to the identified personal information to a providing means for providing the purchaser with the sales target;
market information generating means for deleting information which enables the individual to be identified, from the personal information obtained by the identification to generate market information; and
market information transmitting means for transmitting the market information obtained to the store apparatus.
